(19) United States
(12) Patent Application Publication
(10) Pub. No.: US 2012/0275403 A1
(43) Pub. Date: Nov. 1, 2012

(54) TRANSMISSION OF E-DCH CONTROL CHANNEL IN MIMO OPERATIONS

(75) Inventors: Hong O. Zhang, Manalapan, NJ (US); Benoit Pelletier, Roxboro (CA); Yan Li, Morganville, NJ (US); Joseph S. Levy, Merrick, NY (US); Chao-Cheng Tu, Montreal (CA); Lujing Cai, Morganville, NJ (US); Damian C. Hamme, Horsham, PA (US)

(73) Assignee: INTERDIGITAL PATENT HOLDINGS, INC., Wilmington, DE (US)

(21) Appl. No.: 13/459,133

(22) Filed: Apr. 28, 2012

Related U.S. Application Data
(60) Provisional application No. 61/480,674, filed on Apr. 29, 2011.
(60) Provisional application No. 61/541,413, filed on Sep. 30, 2011.
(60) Provisional application No. 61/591,592, filed on Jan. 27, 2012.
(60) Provisional application No. 61/611,907, filed on Mar. 16, 2012.

(51) Int. Cl. H04W 52/52; H04W 72/02

(52) U.S. Cl. 370/329

(57) ABSTRACT

Systems, methods, and instrumentalities are disclosed herein to determine a gain factor. A user equipment (UE) may determine that an S-E-DPCCH and an E-DPCCH are to be transmitted on a primary stream. The UE may calculate an E-DPCCH gain factor using a gain factor calculation and apply the -DPCCH gain factor. The UE may calculate an E-DPCCH gain factor reduction. For example, the E-DPCCH gain factor reduction may compensate for changes from single stream transmission to multiple stream transmission. The UE may apply the E-DPCCH gain factor reduction to the E-DPCCH gain factor. The UE may apply the E-DPCCH gain factor reduction to an S-E-DPCCH gain factor.

### CROSS-REFERENCE TO RELATED APPLICATIONS

This application claims the benefit of U.S. Provisional Patent Application No. 61/480,674, filed Apr. 29, 2011, U.S. Provisional Patent Application No. 61/541,413, filed Sep. 30, 2011, U.S. Provisional Patent Application No. 61/591,592, filed Jan. 27, 2011, and U.S. Provisional Patent Application No. 61/611,907, filed Mar. 16, 2012, the contents of which are hereby incorporated by reference herein.

### BACKGROUND

High-Speed Downlink Packet Access (HSDPA) is an enhanced 3G (third generation) mobile telephony communications protocol in the High-Speed Packet Access (HSPA) family, which may be referred to as 3.5G, 3G+ or turbo 3G. HSPA allows Universal Mobile Telecommunications System (UMTS) networks to support increased data transfer speeds and data capacity. Further increased data rates can be achieved using Multiple Input and Multiple Output (MIMO) technologies where multiple antennas are used at both the transmitter and the receiver of data. MIMO may be implemented in two forms: multi-user MIMO (MU-MIMO) and single-user MIMO (SU-MIMO). Beyond HSPA, MIMO may be used with 4G (or near-4G) systems, including Long Term Evolution (LTE) and LTE-Advanced networks.

SU-MIMO is a point-to-point multiple antenna connection between one mobile device (also referred to as user equipment (UE) or wireless transmit receive unit (WTRU)), and one base station. SU-MIMO has been adopted in HSDPA Release 7. MU-MIMO enables multiple UEs to communicate with a single base station using the same frequency-domain, code-domain, and time-domain resources. In both forms of MIMO, spatial multiplexing may be used to transmit independent and separately encoded data signals (streams) from each of multiple transmit antennas, thus increasing the bandwidth available in a particular space. The maximum number of streams that may be transmitted in parallel between a UE and a base station will be limited to the least number of antennas configured on either the base station or the UE. MIMO is commonly used in the downlink. MIMO may also be used in the uplink to provide higher data rates.

### SUMMARY

This Summary is provided to introduce a selection of concepts in a simplified form that are further described below in the Detailed Description of Illustrative Embodiments. This Summary is not intended to identify key features or essential features of the claimed subject matter, nor is it intended to be used to limit the scope of the claimed subject matter.

Systems, methods, and instrumentalities are disclosed to determine a gain factor associated with multiple stream uplink operations in a user equipment (UE). A UE may determine that the UE is to transmit on a primary stream and a secondary stream. Transmitting on dual streams may require calculation and/or recalculation of one or more power parameters for one or more channels (e.g., power parameters associated with single stream transmission may not be accurate for dual stream transmission). For example, a pilot power ratio may need to be calculated and/or adjusted, where the pilot power ratio may be affected by a transport block size and/or data rate, method of modulation, etc., associated with dual stream transmission.

The UE may determine a first minimum gain factor for an S-E-DPCCH. For example, the first minimum gain factor may be related to a minimum value received from a network. The UE may determine whether boosting needs to be applied to the S-E-DPCCH (e.g., to the first minimum gain factor). The UE may determine that boosting needs to be applied when one or more of the following is met: an E-TFCI value is above a threshold, the secondary stream carries data, and boosting is enabled. The UE may determine a boosting value. The UE may determine a first gain factor for the S-E-DPCCH based on the first minimum gain factor and the boosting value if present. The first gain factor may be determined based on a maximum value of: a minimum value configured by a network, a value calculated based on E-DPDCH power, or a traffic to secondary pilot ratio. The UE may transmit, over the primary stream, the S-E-DPCCH using the first gain factor. The above may assume that the UE is configured to transmit an E-DPCCH over the primary stream.

The UE may determine a gain factor for an S-DPCCH. The UE may determine a second minimum gain factor for the S-DPCCH. For example, the second minimum gain factor may be related to a minimum value received from a network. The UE may determine whether boosting needs to be applied to the S-DPCCH. The UE may determine a second gain factor for the S-DPCCH based on the second minimum gain factor and the boosting value, if present.

The UE may indicate to the network (e.g., a NodeB) a presence of a secondary stream. For example, the UE may be configured to set a field of an E-DPCCH to indicate the presence of the secondary stream. The field may be a happy bit field of the E-DPCCH. That is, instead of the E-DPCCH happy bit indicating whether or not it is happy with its grant, the E-DPCCH happy bit may indicate the presence of the secondary stream. The UE may set the field of the E-DPCCH to an unhappy state (e.g., its unhappy value) to indicate the presence of the secondary stream. The UE may use a field of the S-E-DPCCH to carry the happy bit from the E-DPCCH, e.g., the information carried by the happy bit on the E-DPCCH may be carried in the field of the S-E-DPCCH. The field of the S-E-DPCCH may be a field (e.g., bit) designated as the happy bit for the S-E-DPCCH.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 illustrates an exemplary UL MIMO transmitter structure;

FIG. 3 illustrates an exemplary UL MIMO transmitter structure;

FIG. 4 illustrates an exemplary UL MIMO transmitter structure;

FIG. 5 illustrates an exemplary UL MIMO transmitter structure and symbol mapping;

FIG. 6 illustrates an exemplary UL MIMO transmitter structure and symbol mapping;

FIG. 7 illustrates an exemplary E-DPCCH and S-E-DPCCH transmission and spreading operation;

FIG. 8 illustrates an exemplary UL MIMO transmitter structure and a DPCCH3 pilot channel;

FIG. 9 illustrates exemplary encoding of an E-TFCI field;

FIG. 10 illustrates exemplary multi-level boosting based on E-TFCI; and

FIG. 11 illustrates exemplary multi-level boosting.

### DETAILED DESCRIPTION OF ILLUSTRATIVE EMBODIMENTS

A detailed description of illustrative embodiments may now be described with reference to the Figures. However, while the present invention may be described in connection with exemplary embodiments, it is not limited thereto and it is to be understood that other embodiments may be used or modifications and additions may be made to the described embodiments for performing the same function of the present invention without deviating therefrom. In addition, the figures may illustrate call flows, which are meant to be exemplary. It is to be understood that other embodiments may be used. The order of the flows may be varied where appropriate. Also, flows may be omitted if not needed and additional flows may be added. As referred to herein, the term UE may refer to a WTRU (e.g., a UE may be a UE, a mobile station, a fixed or mobile subscriber unit, a pager, a cellular telephone, a personal digital assistant (PDA), a smartphone, a laptop, a netbook, a personal computer, a wireless sensor, consumer electronics, and the like).

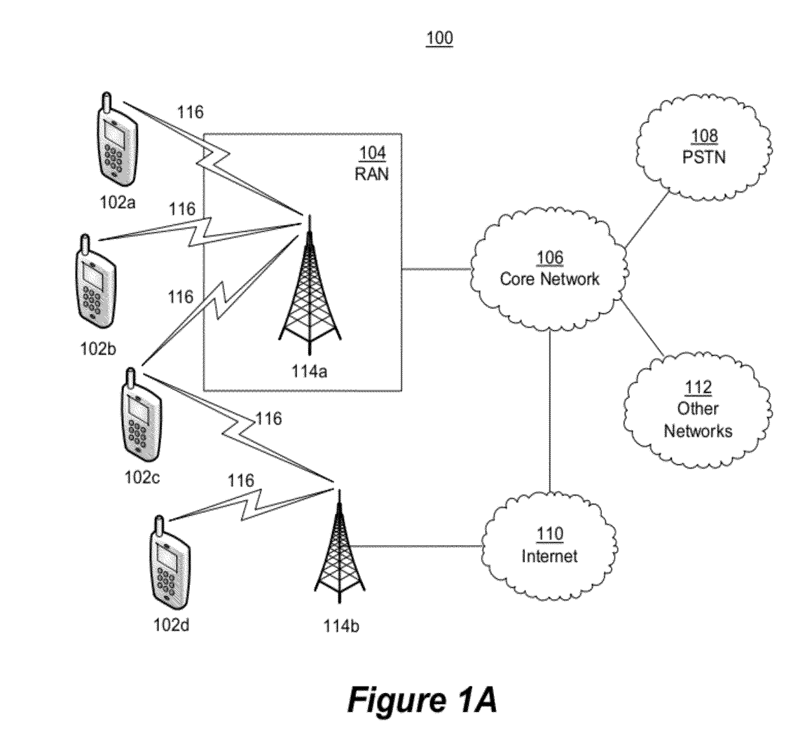

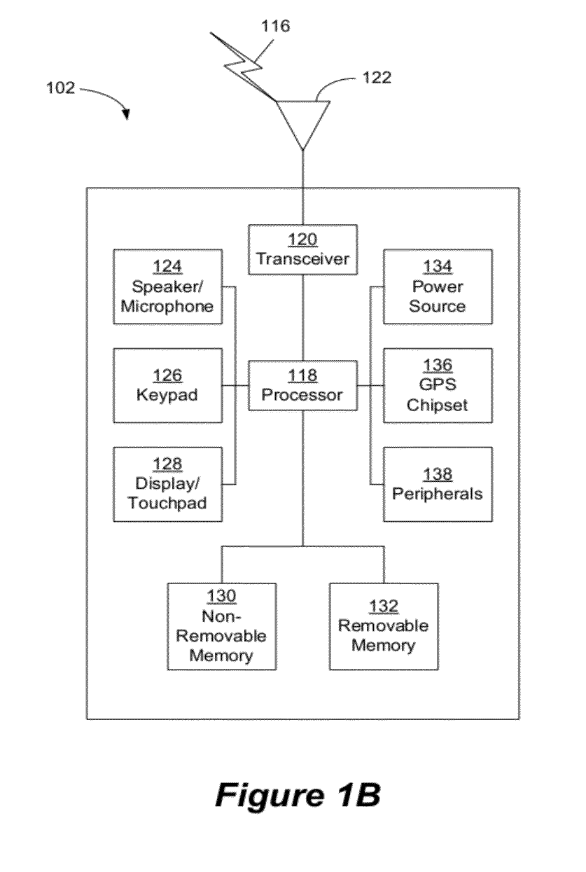

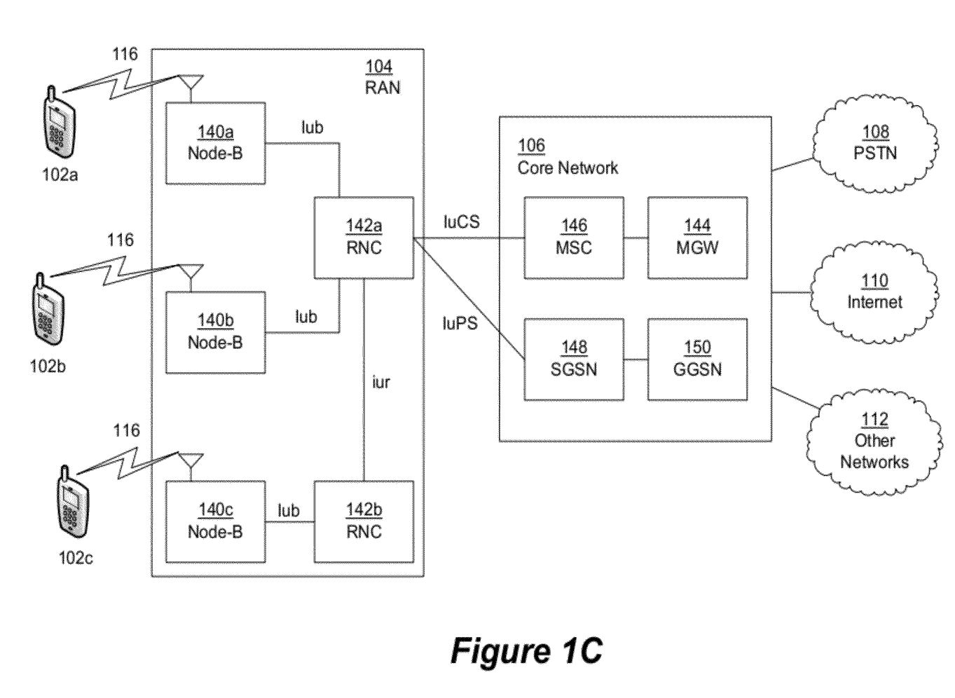

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node B, an eNodeB, a Home Node B, a Home eNodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home NodeB, Home eNodeB, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ a UTRA radio technology to communicate with the WTRUs 102a, 102b, 102c over the air interface 116. The RAN 104 may also be in communication with the core network 106. As shown in FIG. 1C, the RAN 104 may include NodeBs 140a, 140b, 140c, which may each include one or more transceivers for communicating with the WTRUs 102a, 102b, 102c over the air interface 116. The NodeBs 140a, 140b, 140c may each be associated with a particular cell (not shown) within the RAN 104. The RAN 104 may also include RNCs 142a, 142b. It will be appreciated that the RAN 104 may include any number of NodeBs and RNCs while remaining consistent with an embodiment.

As shown in FIG. 1C, the NodeBs 140a, 140b may be in communication with the RNC 142a. Additionally, the NodeB 140c may be in communication with the RNC 142b. The NodeBs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective NodeBs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 104 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

Data transmission needs on the downlink may be larger for users than data transmission needs the uplink. The uplink may use MIMO technologies to reduce a peak data rate imbalance between the two link directions. MIMO stream multiplexing with two transmit and two or more receive antennas may improve the peak data rate available. In some embodiments it may provide up to double the peak data rate available.

Current standards may not provide for multiple stream operations in the uplink and may be limited to single stream enhanced dedicated channel (E-DCH) operations. Multiple stream operations in the E-DCH may include an added physical control channel, e.g., that may control a second E-DCH stream. Where a single inner loop power control is used, and where random channel variations may exist, embodiments disclosed herein may help control the receive quality of the second control channel when sent on the secondary stream. To provide for larger data rates, the conventional E-DCH may improve channel estimation with E-DCH dedicated physical control channel (E-DPCCH) power boosting that may allow for E-DPCCH decision-directed channel estimation, e.g., at a NodeB (NB).

Systems, methods, and instrumentalities are disclosed to determine a gain factor associated with multiple stream uplink operations in a user equipment (UE). A UE may determine that the UE is to transmit on a primary stream and a secondary stream. Transmitting on dual streams may require calculation and/or recalculation of one or more power parameters for one or more channels (e.g., power parameters associated with single stream transmission may not be accurate for dual stream transmission). For example, a pilot power ratio may need to be calculated and/or adjusted, where the pilot power ratio may be affected by a transport block size and/or data rate, method of modulation, etc., associated with dual stream transmission.

The UE may determine a first minimum gain factor for an S-E-DPCCH. For example, the first minimum gain factor may be related to a minimum value received from a network. The UE may determine whether boosting needs to be applied to the S-E-DPCCH (e.g., to the first minimum gain factor). The UE may determine that boosting needs to be applied when one or more of the following is met: an E-TFCI value is above a threshold, the secondary stream carries data, and boosting is enabled. The UE may determine a boosting value. The UE may determine a first gain factor for the S-E-DPCCH based on the first minimum gain factor and the boosting value if present. The first gain factor may be determined based on a maximum value of: a minimum value configured by a network, a value calculated based on E-DPDCH power, or a traffic to secondary pilot ratio. The UE may transmit, over the primary stream, the S-E-DPCCH using the first gain factor. The above may assume that the UE is configured to transmit an E-DPCCH over the primary stream.

The UE may determine a gain factor for an S-DPCCH. The UE may determine a second minimum gain factor for the S-DPCCH. For example, the second minimum gain factor may be related to a minimum value received from a network. The UE may determine whether boosting needs to be applied to the S-DPCCH. The UE may determine a second gain factor for the S-DPCCH based on the second minimum gain factor and the boosting value, if present. Calculation of the second gain factor for the S-DPCCH may be performed in a manner similar to that for the first gain factor for the S-E-DPCCH.

The UE may indicate to the network (e.g., a NodeB) a presence of a secondary stream. For example, the UE may be configured to set a field of an E-DPCCH to indicate the presence of the secondary stream. The field may be a happy bit field of the E-DPCCH. That is, instead of the E-DPCCH happy bit indicating whether or not it is happy with its grant, the E-DPCCH happy bit may indicate the presence of the secondary stream. The UE may set the field of the E-DPCCH to an unhappy state (e.g., its unhappy value) to indicate the presence of the secondary stream. The UE may use a field of the S-E-DPCCH to carry the happy bit from the E-DPCCH, e.g., the information carried by the happy bit on the E-DPCCH may be carried in the field of the S-E-DPCCH. The field of the S-E-DPCCH may be a field (e.g., bit) designated as the happy bit for the S-E-DPCCH.

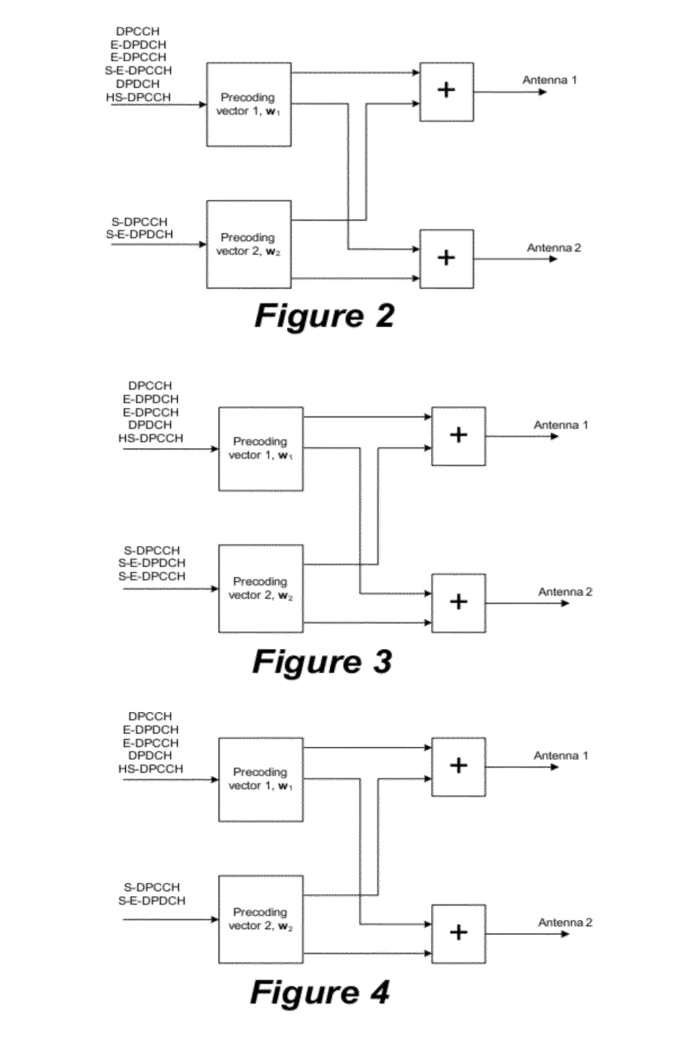

Systems, methods, and instrumentalities may be disclosed to transmit E-DCH control channels (e.g., E-DPCCH and secondary E-DPCCH (S-E-DPCCH)) and encode the S-E-DPCCH. Several UL MIMO transmitter structures may be used, e.g., as shown in FIGS. 2-4. FIG. 2 illustrates an exemplary transmitter structure where E-DPCCH and S-E-DPCCH may be I and Q multiplexed and precoded with a primary precoding vector. FIG. 3 illustrates an exemplary transmitter structure where E-DPCCH and S-E-DPCCH are precoded with different precoding vectors. FIG. 4 illustrates an exemplary transmitter structure with a single E-DPCCH. Although these structures may belong to a similar basic precoded pilot structure, there may be differences in transmitting the two control channels, E-DPCCH and S-E-DPCCH (e.g., one control channel for each data stream).

The [0001]E-DPCCH and S-E-DPCCH may be transmitted in a manner that provides similar decoding performance. That is, when E-DPCCH and S-E-DPCCH are present, the E-DPCCHs may be designed and transmitted such that similar decoding performance may be achieved, e.g., at a NodeB (NB). The transmitter structure of FIG. 2 may be used to transmit the E-DPCCH and S-E-DPCCH over a propagation channel. In that transmitter structure, the E-DPCCHs may be IQ multiplexed using a channelization code, and, the performance of an enhanced phase reference assisted by the E-DPCCH may be degraded, e.g., because of the use of higher order modulation. When the two E-DCH control channels E-DPCCH and S-E-DPCCH are transmitted, E-DPCCH and S-E-DPCCH may be spread by two orthogonal channelization codes.

When transmitting with dual-streams, the received signal-to-noise ratio (SNR) at the NodeB may be different for the control channels compared to single stream transmission. During dual-stream transmission, the required power on the control channels may be changed as compared to single stream transmission. For example, the UE may receive a configuration with an additional power offset for one or more of the control channels. In single stream transmission the UE may apply the conventional gain factors to control channel(s). When the UE is transmitting with dual streams, the UE may increase the power of the control channels by an amount that may be configured by the network. Instead of a power offset or a gain factor offset, the UE may be configured with two separate sets of gain factors. One set of gain factors may be used during single stream transmission and another set of gain factors may be used during multi-stream transmission.

For the transmitter structure illustrated in FIG. 3, spreading E-DPCCH and S-E-DPCCH with orthogonal channelization codes may not provide similar decoding performance for the two E-DPCCHs because they may be transmitted through different eigenmodes and may experience different propagation channels. For this transmitter structure, more transmit power may be allocated to S-E-DPCCH than E-DPCCH. The ratio of the power to be allocated to S-E-DPCCH and E-DPCCH may depend on the strength of the two eigenmodes, which may be known at the NodeB. The UE may determine an S-E-DPCCH gain factor, e.g., at each TTI, for example, based on a measure of the channel quality difference of the two eigenmodes. This measurement or information may be signaled from the NodeB on the downlink, e.g., via an existing or added channel. For example, the UE may use CQI information that may be fed back from the NB, e.g., implicitly or explicitly, to calculate the power ratio between S-E-DPCCH and E-DPCCH so that the gain factor of S-E-DPCCH may be computed as:

$${β}_{sec} = {B}_{ec} \cdot \sqrt{\frac{{CQI}_{ec}}{{CQI}_{sec}}}$$

where β_{ec} may be the gain factor of E-DPCCH and CQI_{ec} and CQI_{sec} may be the channel quality information associated with the first stream E-DPDCHs and second stream S-E-DPDCHs, respectively. This information may be used for enhanced transport format combination (E-TFC) selection and/or restriction for the UE to determine the data rate for multi-stream transmission.

This measure may represent a power offset with respect to a baseline value (e.g., a minimum value) pre-configured by the network. For example, the signaled power measure offset may be Δ_{sec}, the configured quantized amplitude ratio (e.g., the baseline value) for the S-E-DPCCH may be A_{sec}, and the gain factor for the S-E-DPCCH may be β_{sec}. The UE may calculate the gain factor of the S-E-DPCCH based on the signaled power offset measure as follows, which may assume that the power offset Δ_{sec} is expressed in dB and is non-negative:

β_{sec}=β_{c}·{square root over (A_{sec}²·10^{Δ}^{_{sec}}^{/10})}

If the power offset is allowed to be negative, the UE may calculate the gain factor as follows (e.g., to avoid unreliable reception of the S-E-DPCCH):

β_{sec}=β_{c}·\sqrt{max(A_{sec}²,A_{sec}²·10^{Δ}^{_{sec}}^{/} )}

The UE may be configured with a specific power offset for the S-E-DPCCH relative to the power of the S-E-DPDCH. The UE may then calculate the gain factor for the S-E-DPCCH based on this configured power offset and the power calculated for the S-E-DPDCH. The UE may be configured to transmit the S-E-DPCCH with a certain configured power relative to the secondary E-DPDCH stream. For example, the configured offset may be Δ_{sc2st}, the configured quantized amplitude ratio for the S-E-DPCCH may be A_{sec}, the gain factor for the S-E-DPCCH may be β_{sec}, and the gain factor for the k^{th} S-E-DPDCH PhCH for the j^{th} E-TFC having a maximum of L_{max,j} S-E-DPDCH PhCH may be β_{sed,j,k}. The UE may calculate the gain factor for the S-E-DPCCH after having calculated the gain factors for the S-E-DPDCH as follows:

$${β}_{sec} = {β}_{c} \cdot \sqrt{max ( {A}_{sec}^{2} , {10}^{{Δ}_{sc 2 st} \text{/} 10} \cdot {\sum }_{k = 1}^{{L}_{max , j}} {( \frac{{β}_{sed , j , k}}{{β}_{c}} )}^{2} )}$$

In the transmitter structure of FIG. 3, the modulation symbols may be permuted across E-DPCCH and S-E-DPCCH so that at symbol time k and k+1:

$$y ( k ) = [ \begin{matrix}{y}_{1} ( k ) \\ {y}_{2} ( k )\end{matrix} ] = {x}_{1} ( k ) {w}_{1} + {x}_{2} ( k ) {w}_{2} = W [ \begin{matrix}{x}_{1} ( k ) \\ {x}_{2} ( k )\end{matrix} ] and$$

$$y ( k + 1 ) = [ \begin{matrix}{y}_{1} ( k + 1 ) \\ {y}_{2} ( k + 1 )\end{matrix} ] = {x}_{2} ( k + 1 ) {w}_{1} + {{x}_{1} ( k + 1 )}_{2} = W [ \begin{matrix}{x}_{2} ( k + 1 ) \\ {x}_{1} ( k + 1 )\end{matrix} ]$$

where {x₁(k)}ₖ₌₀^{M-1} may be the M modulation symbols in the E-DPCCH after channel coding, {x₂(k)}ₖ₌₀^{M-1} may be the M modulation symbols in the S-E-DPCCH after channel coding,

$$W = [ \begin{matrix}{w}_{1} & {w}_{3} \\ {w}_{2} & {w}_{4}\end{matrix} ] = [ {w}_{1} {w}_{2} ] ,$$

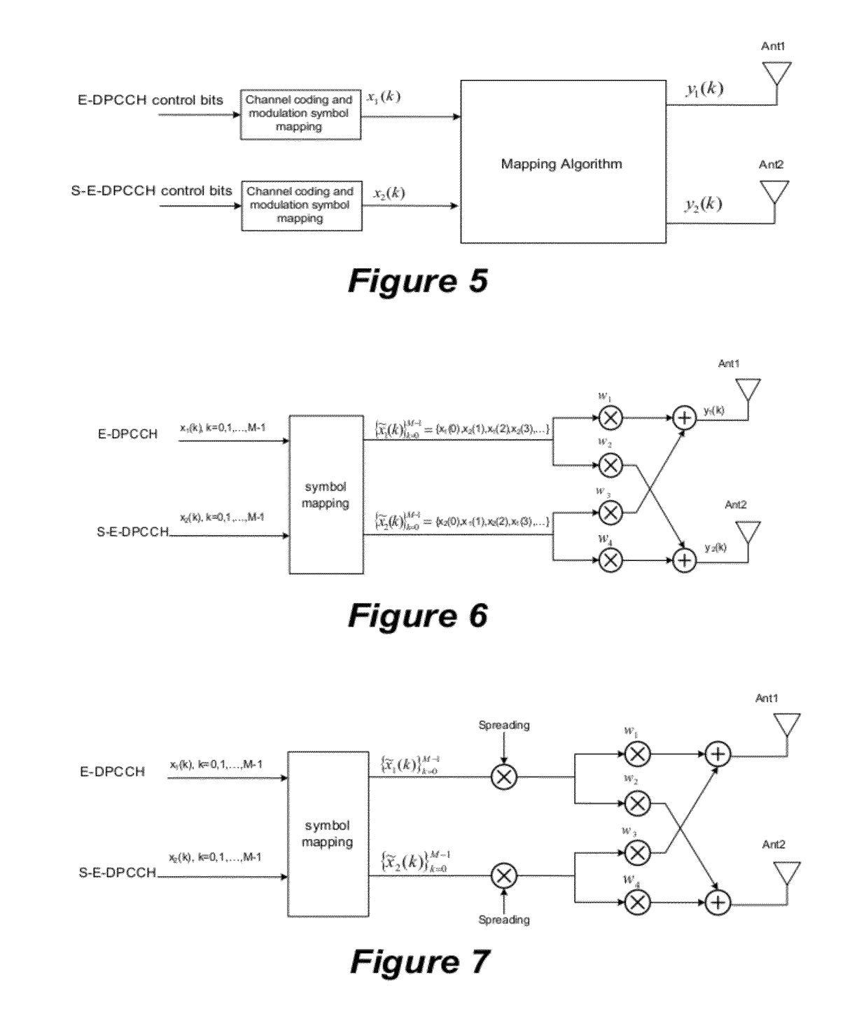

and {y₁(k)}ₖ₌₀^{M-1}{y₁(k)}ₖ₌₀^{M-1} and {y₂(k)}ₖ₌₀^{M-1} may be the outputs seen at physical antenna 1 and 2, respectively. An example of this structure is illustrated in FIG. 5, which illustrates an exemplary mapping between modulation symbols of E-DPCCH and S-E-DPCCH and symbol level signals observed at two physical antennas, where precoding may be part of the mapping.

An example of the mapping algorithm is illustrated in FIG. 6 where a symbol mapping may be performed before applying the precoding matrix W. It may be noted that {\tilde{x}₁(k)}ₖ₌₀^{M-1} and {\tilde{x}₂(k)}ₖ₌₀^{M-1} may be M modulation symbols at the output of the symbol mapping block.

The exemplary symbol mapping block shown in FIG. 6 may be further described mathematically by a matrix P(k) at symbol time index k:

$$P ( k ) = \{ \begin{matrix}[ \begin{matrix}1 & 0 \\ 0 & 1\end{matrix} ] k is even \\ [ \begin{matrix}0 & 1 \\ 1 & 0\end{matrix} ] k is odd\end{matrix}$$

The symbol permutation across E-DPCCH and S-E-DPCCH may be performed according to the following:

$$\tilde{x} ( k ) = [ \begin{matrix}{\tilde{x}}_{1} ( k ) \\ {\tilde{x}}_{2} ( k )\end{matrix} ] = P ( k ) [ \begin{matrix}{x}_{1} ( k ) \\ {x}_{2} ( k )\end{matrix} ] , k = 0 , 1 , … , M - 1$$

FIG. 7 illustrates an exemplary E-DPCCH and S-E-DPCCH transmission scheme with spreading operation. Note that the spreading operation may be performed after symbol mapping or symbol permutation. Two orthogonal channelization codes may be used on two permuted symbol streams.

Enhanced phase reference signals may be used. For rank-2 transmission of MIMO UEs, the transmit power of the primary pilot channel may be boosted to improve channel estimation performance for data channel demodulation. This may be accomplished in non-MIMO UEs by boosting the transmit power of E-DPCCH. For MIMO UEs, E-DPCCH transit power may be boosted to aid demodulation of the associated primary data channel E-DPDCH and S-DPCCH transmit power may be boosted to aid demodulation of the associated secondary data channel S-E-DPDCH. For example, the phase reference signal enhancement for each data stream may be performed independently.

Due to a presence of inter-stream interference in dual-stream transmission, having an estimation of the channel associated with the interference stream may be beneficial for demodulation of the desired steam. In dual-stream transmission, the transmit power of the secondary pilot channel may be boosted if the transmit power of the primary pilot channel is boosted. The channel seen by the primary stream E-DPDCH may be stronger than the one seen by the secondary stream S-E-DPDCH.

S-DPCCH transmit power may be boosted for the purpose of phase reference enhancement. The NB may need to decode the E-DPCCH in order to generate channel state information to feedback PCI weights. This may not be practical in some implementations, e.g., where there are short latency requirements for closed-loop operations. It may be desirable not to boost S-DPCCH transmit power directly as enhanced phase reference. Enhanced phase reference may be achieved using one or more of the following.

The transmit power of S-E-DPCCH may be boosted, e.g., if it is available. This may be implemented when the S-E-DPCCH is transmitted using the S-E-DPDCH pre-coding weights, e.g., as may be the case for the transmitter structure shown in FIG. 3. The total transmit power of S-E-DPCCH after boosting may be similar to the total transmit power of E-DPCCH.

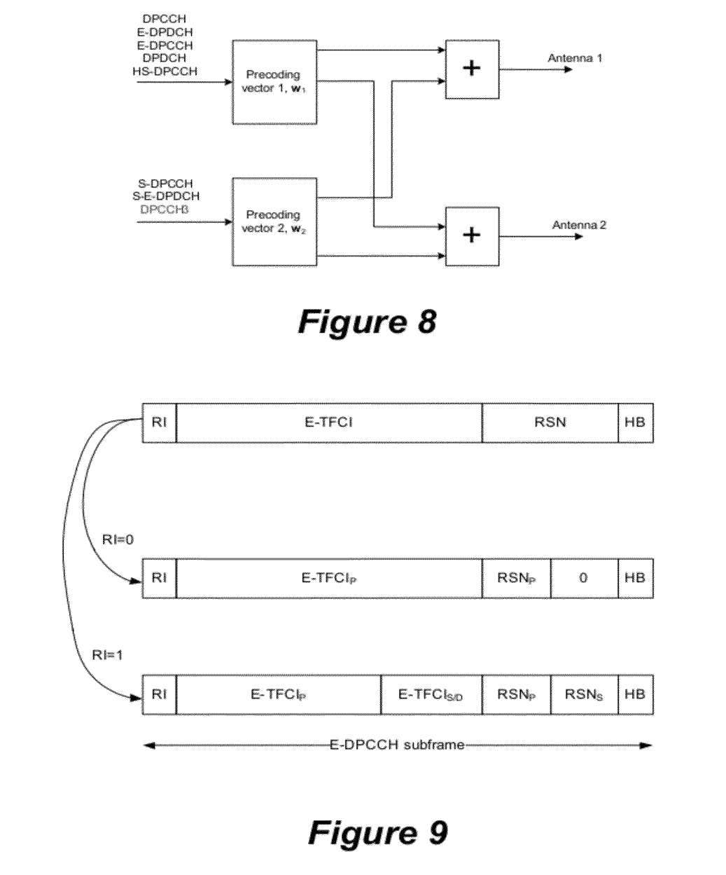

A third pilot channel DPCCH3 may be transmitted and may be precoded with the precoding vector applied to S-DPCCH when enhanced phase reference is needed, e.g., as shown in FIG. 8.

An S-DPCCH with additional pilot bits may be used when enhanced phase reference is needed, while the S-DPCCH transmit power may be used for normal phase reference. For example, S-DPCCH may include six or eight pilot bits for normal phase reference, and an S-DPCCH with a 10-bit pilot may be used for enhanced phase reference.

Encoding of control information may be disclosed. The following terminology may be used.
E-TFC E-DCH transport format combination;
E-TFCI E-TFC index;
E-TFCI_{P} E-TFC index for the primary stream;
E-TFCI_{S} E-TFC index for the secondary stream;
E-TFCI_{J} Joint E-TFC index for primary and secondary stream;
RSN Retransmission sequence number;
RSN_{P} RSN for the primary stream; and
RSN_{S} RSN for the secondary stream.

A UE may be configured to operate with dual stream UL MIMO operations with dual transport blocks (TBs). Subcases may include one or two control channels (e.g., single E-DPCCH or dual E-DPCCH (e.g., E-DPCCH and S-E-DPCCH)), and, whether the two transport blocks are linked to an RSN value (e.g., joint or independent HARQ processes). The UE may transmit one or more of the following. The transmission may be dependent on a particular configuration.
E-TECI_{P}: E-TFCI for first stream (e.g., 7 bits);
E-TFCI_{S}: E-TFCI for second stream, if present (e.g., 7 bits);
RSN information, joint or independent (e.g., 2 bits each);
Rank indication (RI) (e.g., 1 bit); and
Happy bit (e.g., 1 bit).
   The following describes implementations by which the UE may process and/or transmit information over one and two control channels.

In the case of a single control channel, the existing E-DPCCH may not have the capacity to carry the needed information. For example, the existing E-DPCCH may be designed to encode 10 bits, e.g., 7 bits for E-TFCI, 2 bits for RSN, and 1 bit for the happy bit, and may use a subset of the second order Reed-Muller code.

Following are implementations for encoding and/or transmitting E-DCH control information for UL MIMO operations in the context where a single control channel is configured. These implementations may be used alone or in any combination.

An implicit ranking indication may be used. A ranking indication may be referred to as a ranking. A UE may be configured to multiplex two E-TFCI fields, the E-TFCI_{P} and E-TFCIs, e.g., in addition to one or two RSN fields and the happy bit. The rank may be indicated implicitly by the UE via the combination of the E-TFCI fields. For example, the E-TFCIs value 0 may be reserved to indicate that no transport block (TB) is carried on the secondary stream. This may be implemented as the existing entry for the E-TFCI value 0, which may correspond to the special 18 bits value to carry the SI, which may be used when the UE has no data in its buffer and may be transmitted over the primary stream.

An explicit ranking indication may be used. A UE may be configured to multiplex a rank indication bit, e.g., in addition to one or two E-TFCI fields, one or two RSN fields, and the happy bit. The UE may use two sets of TBS tables: one table (e.g., the legacy TBS table) for single rank (e.g., rank one) transmission and another TBS or set of TBS tables for a rank-two transmission. The TBS tables may be created. A TBS table may be configured as a subset of an existing legacy TBS table.

The UE may be configured to use a subset of the E-TFC combinations for rank-two transmissions. When the UE selects rank-two transmission, which may include setting the RI appropriately, a subset of the legacy E-TFC table may be used for the primary stream. The E-TFCI field size for the primary stream may be reduced accordingly (e.g., from 7 to 4 bits). The E-TFCI field for the secondary stream may have a reduced size, e.g., each value from the legacy table may not be necessary.

When transmitting with rank-two, the UE may multiplex the values of the E-TFCI_{P} and E-TFCIs in a single E-TFCI field using the E-TFCI_{P} size when rank-one transmission is used. The UE may encode the secondary E-TFCI using differential indexing, e.g., as described herein.

FIG. 9 illustrates exemplary conditional encoding of the E-TFCI field, where the first line may show generic content of the E-DPCCH. The second line may show the content when the UE selects rank-one transmission (e.g., RI=0). In such a case, a single E-TFCI for the primary stream may be encoded and transmitted. Similarly a single RSN value may be needed (e.g., for the primary stream) and if bits are reserved for the RSN of the secondary stream, it may take, for example, value 0 or other predefined value.

The third line may show the content of the E-DPCCH when the UE selects rank-two transmission (e.g., RI=1). In such a case, the UE may multiplex the content of both E-TFCI (e.g., E-TFCI_{P} and either E-TFCI_{S} or E-TFCI_{D}) in the E-TFCI field. One RSN value for each stream may be needed and may be transmitted in the E-DPCCH.

Channel coding may be disclosed. As the E-DPCCH carries more information for dual-stream MIMO operations, it may not be useful to use the legacy channel coding scheme. To support a larger amount of data, the UE may use one or more of the following approaches: the UE may use a smaller spreading factor for the E-DPCCH (e.g., SF=128 instead of SF=256); the UE may use an extended Reed-Muller block code; and the UE may use a convolutional encoder (e.g., rate ½ or rate ⅓) with puncturing, which may include physical layer interleaving.

A UE may use two channels to carry the control information, e.g., the E-DPCCH and the S-E-DPCCH. The S-E-DPCCH may carry control information associated with the secondary stream. The UE may indicate the rank by transmitting or not transmitting the S-E-DPCCH. When rank-one transmission is used, the UE transmission may be limited to the E-DPCCH and when rank-two transmission is used the UE may transmit the E-DPCCH and S-E-DPCCH.

The S-E-DPCCH may carry the E-TFCI and the RSN for the secondary stream (e.g., the E-TFCI_{S} and RSN_{S}). The S-E-DPCCH may carry the Happy Bit. The HB may take the same value as the HB carried on the E-DPCCH or may take a different value. The UE may use differential indexing for encoding of the secondary stream E-TFCI, for example, as described herein. In such a case, the S-E-DPCCH may carry the E-TFCI_{D}.

The UE may indicate the rank explicitly to the NB, e.g., using one or more of the following. A bit on the primary E-DPCCH may be added. For example, a field carrying the indication may be added to the E-DPCCH. The UE may set this field to 1 when there is a secondary stream present. The happy bit of the E-DPCCH may be used to indicate rank. For example, the UE may set the happy bit of the primary stream E-DPCCH to indicate the presence of a secondary stream. The happy bit field of the secondary stream E-DPCCH (S-E-DPCCH) may be used to carry the actual happy bit (e.g., the conventional happy bit carried on the primary stream). A least likely value of the happy bit may be chosen to indicate the presence of the secondary stream. Using the least likely value may avoid NB processing. For example, the UE may be configured to use the value “Not Happy” on the primary stream E-DPCCH to indicate the presence of a secondary stream. The UE may be configured to use the value “Happy” on the primary stream E-DPCCH to indicate the presence of a secondary stream. An indication, e.g., an added bit, on E-TFCI may be provided. The indication may include one or more of the following. A subset of E-TFCI values may be combined with dual-stream and NB, e.g., upon reception of one of the E-TFCI_{S}, the NB may verify the presence of a secondary stream. A subset of E-TFCI values may be reserved to indicate dual-stream. For example, an E-TFC table may be created, e.g., with the last few entries indicating dual stream. See Table 2 as an example. This approach may be used in the case for dual control channels. A value of RSN may be used. The UE may be configured to transmit an RSN value to indicate the presence of a secondary stream. For example, one of the four RSN values may be used. A DPCCH and/or S-DPCCH field may be used. The transmitted rank may be explicitly indicated in a field of the DPCCH and/or S-DPCCH, e.g., a field that may be created. The value of the indication may be repeated during the duration of the E-DCH subframe.

An S-E-DPCCH and S-DPCCH power calculation may be disclosed. The UE may need to calculate the power of the S-DPCCH and S-E-DPCCH dynamically based on the transmitted data, e.g., on each stream. In UL CLTD operations, the UE may be configured to calculate the S-DPCCH gain factor based on one or more of the following: a maximum of a minimum configured value, a calculated value based on the E-DPDCH power, and a configured traffic to secondary pilot ratio. This may help prevent a possible imbalance between the total pilot power on the primary stream and the S-DPCCH power, which may allow the NB to make appropriate channel estimation for the purpose of generating the next weight indication. In dual-stream operations, the UE may need to provide appropriate pilot power. The total pilot power for the secondary stream may depend on the E-TFC of the primary and/or the secondary stream.

Determining the gain factor for the S-DPCCH and/or S-E-DPCCH may comprise the UE determining the minimum gain factor to use and whether or not to apply boosting to one or the other channel, and, determining the actual boosting value, e.g., if required. The UE may be configured with a minimum value for the S-DPCCH gain factor (e.g., β_{sc}²=A_{sc}²β_{c}², where A_{sc} and β_{c} may be values signaled by the network) and determine whether or not to apply further “boosting” to the S-DPCCH. The UE may determine whether or not to apply boosting, for example, based on one or more of the following (e.g., triggers to apply boosting): the E-TFCI on the primary stream is above a configured threshold, E-TFCIsc,boost (e.g., the threshold may be the E-TFCIec,boost value, a value signaled by the network, etc.); the E-DPCCH is being boosted, e.g., the E-TFCI on the primary stream is above an E-TFCIec,boost threshold; the E-TFCI on the secondary stream is above a configured threshold, E-TFCIsc,boost (e.g., this threshold may also be the E-TFCIec,boost value, a value signaled by the network, etc.); E-DPCCH boosting is enabled; S-DPCCH boosting is enabled; S-E-DPCCH boosting is enabled; the secondary stream carries data; and the secondary E-DPDCH (S-E-DPDCH) has non-zero power. This approach may be used by the UE to determine whether or not to apply S-E-DPCCH power boosting (e.g., with analogous terminology and variables).

Systems, methods, and instrumentalities may be disclosed to determine the gain factor when an S-E-DPCCH is not present on a secondary stream. There may be no E-DPCCH or S-E-DPCCH transmitted on the secondary stream; or, if there is an E-DPCCH or S-E-DPCCH transmitted on the secondary stream it may be assumed that it is not used for channel estimation purposes by the NodeB. The NodeB may need to derive the channel estimate for the secondary stream based on the S-DPCCH. For channel estimation associated with demodulation purposes, when a secondary E-DPDCH is present, the UE may set the gain factor of the S-DPCCH appropriately. Calculating the gain factor for the S-DPCCH on a secondary stream may be provided. One or more of the following may be used.

A UE may determine the S-DPCCH gain factor βsc such that the power of the S-DPCCH is equal to the total pilot power on the primary stream, e.g., the power of the DPCCH and E-DPCCH. The UE may apply such calculation when E-DPCCH boosting is enabled. For example, this may be provided by:

$${β}_{sc} = {β}_{c} \sqrt{max ( {A}_{sc}^{2} , ( 1 + \frac{{β}_{ec}^{2}}{{β}_{c}^{2}} ) )}$$

where β_{ec} is the E-DPCCH gain factor calculated by the UE including potential power boosting, and, the maximum operation may ensure that the UE applies at least the minimum amount of power configured. The value of the E-DPCCH gain factor may be determined by the UE using other calculations, e.g., see 3GPP TS 25.214.

The UE may determine the S-DPCCH gain factor β_{sc} such that the ratio of S-DPCCH to total pilot power on the primary stream equals a preconfigured ratio (e.g., β_{SP2PP} in the log-domain). For example, this may be provided by:

$${β}_{sc} = {β}_{c} \sqrt{max ( {A}_{sc}^{2} , {10}^{{Δ}_{SP 2 PP} \text{/} 10} ( 1 + \frac{{β}_{ec}^{2}}{{β}_{c}^{2}} ) )}$$

In an example, this ratio may be dynamically signaled by the NodeB to the UE. More specifically, the UE may use the SNR or power offset signaled by the NodeB for the purpose of indicating the relative quality of the secondary stream (e.g. the signal or quantity used by the UE to determine the TBS on the secondary stream) for this purpose.

The UE may determine the S-DPCCH gain factor β_{sc} such that the ratio of total traffic to pilot power on the secondary stream is equal to a configured ratio (e.g., Δ_{ST2P} in the log-domain). For example, the UE may determine the S-DPCCH gain factor β_{sc} based on the gain factor of the secondary stream E-DPDCH. For example, this may be provided by:

$${β}_{sc} = {β}_{c} \sqrt{max ( {A}_{sc}^{2} , \frac{{\sum }_{k = 1}^{L} {β}_{sed , k}^{2} \text{/} {β}_{c}^{2}}{{10}^{{Δ}_{ST 2 P} \text{/} 10}} )}$$

The total amount of pilot power required for data demodulation in conventional systems may be based on a fixed power offset with respect to the power on the data channel. The power on the data channel and the associated transport format (TF) may be directly related to the amount of data to be transmitted via a pre-configured set of reference power-offsets, E-TFCIs. In UL MIMO, this relation between transmit power, TF, and transport block size (TBS) may no longer hold for the secondary stream. In an exemplary implementation of UL MIMO operations for HSUPA, the transport format and power for the secondary stream may be set independent of the TBS carried on the secondary stream. That is, in some implementations it may not be relevant to determine the amount of pilot power required for demodulation to the actual traffic (e.g., data) power.

Determining a S-DPCCH gain factor may be disclosed. When no S-E-DPCCH is present on the secondary stream, the UE may determine the S-DPCCH gain factor βsc based on the amount of data carried on the secondary stream. For example, the UE may determine a set of conventional and/or virtual gain factors based on conventional formulas. For example, the UE may determine a virtual gain factor of the secondary stream E-DPDCH β'sed,k. This virtual gain factor for the secondary stream may be different than the actual gain factor used for transmission and may be calculated, for example, based on conventional formulas, e.g., using reference power offsets associated with dual-stream transmission and/or using the reference power offsets associated with single-stream transmission, for example, when one set of reference power offsets is configured.

For the above, the UE may calculate a virtual S-E-DPDCH gain factor based on a number of bits to be transmitted. As explained below, the virtual gain factor may correspond to the conventional gain factor. The UE may perform one or more of the following. The UE may determine the transport block size (TBS) and/or the number of bits to transmit on the secondary stream (e.g., using conventional formulas with an SNR offset configured by the network). The UE may determine the number of S-E-DPDCH codes that may be required using conventional transport format selection rules (e.g. as described in TS 25.212 v.10.0.0). The UE may determine the conventional gain factor or set of gain factors for that TBS. The UE may use the conventional formulas for determining the gain factor (e.g. as described in TS 25.214 v.11.1.0), for example, as if the transport block is to be transmitted on the primary stream. The conventional gain factor for the secondary stream may be calculated as follows:

$${β}_{sed , i , conv} = {β}_{ed , ref} \sqrt{\frac{{L}_{e , ref}}{{L}_{e , i}}} \sqrt{\frac{{K}_{e , i}}{{K}_{e , ref}}} \cdot {10}^{( \frac{Δ harq}{20} )}$$

where the reference parameters (e.g., with “ref” in subscripts) may be configured by the network and the number of bits Ke,i is related to the TBS and Le,i is the number of S-E-DPDCH codes used, which the UE may determine, for example, using the conventional rules for transport format selection. The UE may use reference gain factors for dual-stream operations, e.g., if such references gain factors are configured by the network. The UE may use the reference gain factors as configured by the network and may take into account an additional offset configured by the network. The UE may determine the S-DPCCH gain factor by using the conventional gain factor for the secondary stream TBS. This may be achieved, for example, by using the conventional formula using this conventional gain factor and the traffic-to-power ratio as configured by the network. For instance, using (e.g. as described in TS 25.214 v.11.1.0):

$${β}_{sc , i , uq} = {β}_{c} \cdot \sqrt{max ( {A}_{sc}^{2} , \frac{{\sum }_{k = 1}^{{K}_{max , j}} {( \frac{{β}_{sed , i , conv , k}}{{β}_{c}} )}^{2}}{{10}^{\frac{{Δ}_{T 2 SP}}{10}}} )}$$

where β_{sed,i,conv,k} is the conventional gain factor for S-E-DPDCH for channelization code k (e.g., following the conventional rules to take into account the spreading factor, for example, as described for example in TS 25.214 v.11.1.0). The UE may be configured with an additional traffic-to-secondary-pilot ratio that it may use, e.g., for the calculation of the S-DPCCH gain factor when an S-E-DPDCH is present.

The UE may apply the gain factor to the S-DPCCH, and, may use a different gain factor for the S-E-DPDCH than the conventional one used for the calculation of the S-DPCCH gain factor. For example, the UE may be configured to use the same gain factor for the S-E-DPDCH that is used for the E-DPDCH.

Under the above approach, the UE may be configured so that the gain factor for the S-DPCCH is above a value that may be required by single stream operations (e.g., S-DPCCH boosting in UL CLTD). This may be provided, for example, by the UE calculating the gain factor for the S-DPCCH assuming single-stream transmission and taking the maximum of the calculated values. For instance, let β_{sc,ss} be the single-stream boosted gain factor for the S-DPCCH; β_{sc,ss} may be calculated using one or more of the following:

$${( \frac{{β}_{sc , ss}}{{β}_{c}} )}^{2} = \frac{{\sum }_{k = 1}^{{K}_{max , i}} {( \frac{{β}_{ed , i , k}}{{β}_{c}} )}^{2}}{{10}^{\frac{{Δ}_{T 2 SP}}{10}}} - 1.$$

$${( \frac{{β}_{sc , ss}}{{β}_{c}} )}^{2} = \frac{{\sum }_{k = 1}^{{K}_{max , i}} {( \frac{{β}_{ed , i , k}}{{β}_{c}} )}^{2}}{{10}^{\frac{{Δ}_{T 2 SP}}{10}}} .$$

The gain factor may be calculated as:

$${β}_{sc} = {β}_{c} \sqrt{max ( {A}_{sc}^{2} , \frac{{β}_{sc , ss}^{2}}{{β}_{c}^{2}} , \frac{{\sum }_{k = 1}^{{K}_{max , i}} {β}_{sed , i , k}^{2} \text{/} {β}_{c}^{2}}{{10}^{{Δ}_{ST 2 P} \text{/} 10}} )}$$

where β_{sed,i,k} is the calculated gain factor for the k^{th} S-E-DPDCH for E-TFC i, and K_{max,i} is the maximum number of S-E-DPDCHs used for E-TFC i.

The UE may be configured with two values of traffic to secondary pilot ratios, a first value for rank-1 transmission and a second value for rank-2 transmission. The UE may determine the transmission rank and choose a traffic-to-secondary-pilot ratio for calculating the gain factor for the S-DPCCH. For example, let ΔT2SP be the conventional traffic-to-secondary-pilot ratio and let ΔT2SP₂ be the traffic-to-secondary-pilot ratio configured for rank-2 transmission. In this example, the UE may be configured to use ΔT2SP in calculating the S-DPCCH gain factor for rank-1 transmission and ΔT2SP₂ in calculating the S-DPCCH gain factor for rank-2 transmission. The UE may receive the values ΔT2SP and ΔT2SP₂ (e.g., in the form of an index on a pre-determine table) via RRC signaling. The UE may use the conventional formula for calculating the S-DPCCH gain factor. The S-DPCCH unquantized gain factor may be provided by:

$${β}_{sc , i , uq} = {β}_{c} \cdot \sqrt{max ( {A}_{sc}^{2} , \frac{{\sum }_{k = 1}^{{K}_{max , i}} {( \frac{{β}_{ed , i , k}}{{β}_{c}} )}^{2}}{{10}^{\frac{{Δ}_{T 2 SP}}{10}}} )} ,$$

for rank-1 transmission (e.g., S-E-DPDCH power is zero), or

$${β}_{sc , i , uq} = {β}_{c} \cdot \sqrt{max ( {A}_{sc}^{2} , \frac{{\sum }_{k = 1}^{{K}_{max , i}} {( \frac{{β}_{ed , i , k}}{{β}_{c}} )}^{2}}{{10}^{\frac{{Δ}_{T 2 {SP}_{2}}}{10}}} )} ,$$

for rank-2 transmission (e.g., S-E-DPDCH power is non zero).
(where variables may be as described herein).

Systems, methods and instrumentalities may be disclosed to determine a gain factor when there is an S-E-DPCCH on the secondary stream. The UE may be configured to transmit the S-E-DPCCH on the secondary stream. The UE may determine the power of the S-DPCCH and S-E-DPCCH in such a way as to provide enhanced phase reference for demodulation.

The UE may be configured with a fixed S-E-DPCCH gain factor. For example, the S-E-DPCCH gain factor may take the value of the E-DPCCH gain factor. The UE may determine the power of the S-DPCCH based on the assumption that the S-E-DPCCH is used for channel estimation by the NodeB and based on a configured secondary stream traffic to total pilot power ratio Δ_{ST2TP}. For example, this may be provided by:

$${β}_{sc} = {β}_{c} \sqrt{max ( {A}_{sc}^{2} , \frac{{\sum }_{k = 1}^{{K}_{max , i}} {β}_{sed , i , k}^{2} \text{/} {β}_{c}^{2}}{{10}^{{Δ}_{ST 2 TP} \text{/} 10}} - \frac{{β}_{sec}^{2}}{{β}_{c}^{2}} )}$$

where β_{sec}² is the gain factor of the secondary E-DPCCH or S-E-DPCCH.

The UE may be configured to provide that the gain factor of the S-DPCCH is above a value, e.g., a value needed for single stream operations (e.g., S-DPCCH boosting in UL CLTD). The UE may calculate the gain factor for the S-DPCCH assuming single-stream transmission and take the maximum of the calculated values. For instance, let β_{sc,ss} be the single-stream gain factor for the S-DPCCH, e.g., as calculated above. The gain factor may be calculated as:

$${β}_{sc} = {β}_{c} \sqrt{max ( {A}_{sc}^{2} , \frac{{β}_{sc , ss}^{2}}{{β}_{c}^{2}} , \frac{{\sum }_{k = 1}^{{K}_{max , i}} {β}_{sed , i , k}^{2} \text{/} {β}_{c}^{2}}{{10}^{{Δ}_{ST 2 TP} \text{/} 10}} - \frac{{β}_{sec}^{2}}{{β}_{c}^{2}} )}$$

where β_{sed,i,k} is the calculated gain factor for the k^{th} S-E-DPDCH for E-TFC i, and K_{max,i} is the maximum number of S-E-DPDCHs used for E-TFC i.

A UE may be configured with a fixed S-DPCCH gain factor (e.g., when transmitting dual stream) and may determine the S-E-DPCCH gain factor based on a configured secondary stream traffic to total pilot power ratio Δ_{ST2TP}. For example, this may be provided by:

$${β}_{sec} = {β}_{c} \sqrt{max ( {A}_{sc}^{2} , \frac{{\sum }_{k = 1}^{{K}_{max , i}} {β}_{sed , i , k}^{2} \text{/} {β}_{c}^{2}}{{10}^{{Δ}_{ST 2 TP} \text{/} 10}} - \frac{{β}_{sc}^{2}}{{β}_{c}^{2}} )} .$$

The UE may be configured to use the E-DPCCH gain factor for S-E-DPCCH. The S-DPCCH may be transmitted with boosting, if configured, or the UE may be configured to not boost the S-DPCCH when there is power on the secondary stream.

Systems, methods, and instrumentalities may be disclosed to determine the gain factor of the S-E-DPCCH and E-DPCCH when both are transmitted on the primary stream. For example, the UE may be configured to transmit the S-E-DPCCH and E-DPCCH on the same stream, e.g., the primary stream. The UE may be configured to transmit the S-E-DPCCH and E-DPCCH with a similar (e.g., same or related) gain factor or power. The UE may be configured to calculate the E-DPCCH gain factor, e.g., using a conventional E-DPCCH gain factor calculation, and apply the gain factor to the S-E-DPCCH.

The UE may be configured to calculate and apply the E-DPCCH gain factor, e.g., using a conventional E-DPCCH gain factor calculation, with a configurable gain factor reduction. The UE may apply the gain factor reduction to the S-E-DPCCH and E-DPCCH, e.g., both channels may be transmitted with similar power. In an example, the gain factor reduction may be \sqrt{2} corresponding to 3 dB power reduction or half power. This approach may allow the UE to transmit with a similar T2TP, which may assume that the NodeB uses E-DPCCH and S-E-DPCCH as decision-direct pilots.

This approach may be implemented using the following example. Referring to terminology disclosed herein, the unquantized E-DPCCH gain factor for E-TFCI i may be calculated by the UE using the following:

$${β}_{ec , i , uq} = {β}_{c} \cdot \sqrt{max ( {A}_{ec}^{2} , \frac{{\sum }_{k = 1}^{{k}_{max , i}} {( \frac{{β}_{ed , i , k}}{{β}_{c}} )}^{2}}{{10}^{\frac{{Δ}_{T 2 TP}}{10}}} - 1 )}$$

for rank-1 transmission (e.g., S-E-DPDCH power is null), and

$${β}_{ec , i , uq} = \frac{{β}_{c}}{\sqrt{2}} \cdot \sqrt{max ( {A}_{ec}^{2} , \frac{{\sum }_{k = 1}^{{k}_{max , i}} {( \frac{{β}_{ed , i , k}}{{β}_{c}} )}^{2}}{{10}^{\frac{{Δ}_{T 2 TP}}{10}}} - 1 )}$$

for rank-2 transmission (e.g., S-E-DPDCH power is non-null)

The UE may determine that for a rank-1 transmission, the S-E-DPCCH is not transmitted (e.g., gain factor is null) and that for a rank-2 transmission the S-E-DPCCH gain factor is equal to the E-DPCCH gain factor, e.g., β_{sec}=β_{sec}.

Systems, methods and instrumentalities may be disclosed to determine a gain factor when the DPCCH is not used for channel estimation. In HSPA downlink MIMO operations, the NodeB may transmit the HS-PDSCH with constant power, e.g., for the duration of a 2 ms TTI subframe. The pilot signal from the downlink may be transmitted with constant power. This approach may allow improved channel estimation, e.g., in slowly varying channels, and may improve reception in frequency selective channels.

On the uplink, the UE may transmit its channels with a fixed power with respect to the DPCCH, which may vary on a slot-by-slot basis based on downlink TPC commands. The NodeB may receive the UE signal with variations in power, which may degrade the quality of the channel estimates. This may be undesirable for MIMO and/or 64QAM operations where high quality channel estimates may be needed. Systems, methods and instrumentalities may be disclosed to transmit constant power pilot references, which may improve quality.

A UE may be configured to transmit with a constant pilot power reference. The UE may be configured to determine whether or not to transmit with constant pilot power and calculate a gain factor and/or power(s), and, apply to the transmitted signal(s). The UE may indicate to the NodeB whether or not it is using constant pilot power.

Systems, methods and instrumentalities may be disclosed for a UE to determine whether or not to transmit with a constant power pilot reference. One or more of the following may be used.

The UE may be configured, e.g., via RRC signaling, to transmit with a constant pilot power reference. The UE may be configured to transmit with a constant pilot power reference based on an E-DCH transmission format. For example, the UE may be configured to transmit with a constant power reference when one or more of the following are met: the UE transmits with 64QAM modulation; the UE transmits with MIMO; the primary stream TBS that the UE transmits is above a threshold; the secondary stream TBS that the UE transmits is above a threshold; the sum of the TBS from both the primary and the secondary stream that the UE transmits is above a threshold; etc. The threshold values may be fixed in specifications or signaled to the UE, e.g., via RRC signaling. The UE may be configured to transmit with a constant pilot power reference when it receives a specific configuration from the network. For example, the UE may be configured to transmit with a constant pilot power reference when one or more of the following are met: the UE is configured to transmit with a constant power reference; the UE is configured to operate with 64QAM modulation; the UE is configured to operate with MIMO; the UE is configured to operate with both 64QAM and MIMO; the UE receives an absolute grant (e.g., on the E-AGCH) above a pre-configured threshold; the UE serving grant is above a pre-configured threshold; the UE receives a certain value of the absolute grant or a certain combination of bits (e.g., on the E-AGCH); the UE receives a specific HS-SCCH order; the UE receives a special L2 (e.g., MAC-level) message; etc. The UE may be configured to transmit with a constant pilot power by tracking downlink commands received from the NodeB. The UE may monitor for a specific pre-determined sequence of downlink commands, e.g., when the UE determines that it has received the specific pre-determined sequence of downlink commands, it may transmit with a constant pilot power.

TPC command(s) may be used. The UE may use a TPC downlink command to determine whether or not to transmit with a constant pilot power. Variation of the DPCCH power may be governed via slot-by-slot-based TPC commands. To maintain the quality of channel estimates, it may be desirable to avoid significant changes in DPCCH power. For example, the UE may determine whether or not a resulting DPCCH power may degrade the quality of channel estimates at the NodeB. The UE may verify, e.g., continuously, whether or not the previous N TPC commands comprise M<N power-up or power-down commands. In such a case, the UE may determine that the DPCCH power variation is above a tolerable range and issue a DPCCH power hold configuration. The UE may track, e.g., continuously, whether or not the previous TPC commands comprise K consecutive power-up or power-down commands. If so, the UE may issue a DPCCH power hold configuration. The choice of the parameters N, M, and K may be signaled from the network, pre-determined from the specifications, dynamically updated from an adaptive algorithm at the UE, etc.

When the UE is configured to operate with a constant pilot power, the UE may receive TPC commands and apply them. For example, the UE may apply the TPC received in a specific slot of a sub-frame and ignore the received TPC from other slots. The specific slot may, for example, be determined implicitly via timing or explicitly via RRC configuration. The UE may receive three TPC commands in a sub-frame and apply a function to determine the result, e.g., the UE may be configured to apply a majority voting rule to determine the resulting power update for the sub-frame. The UE may use a single TPC from the sub-frame, and, the other TPC fields (e.g., un-used when the UE is configured to operate with a constant pilot power) may be used to carry other information, e.g., TPI.

The UE may use a relative grant, e.g., as received from the E-RGCH downlink command, to determine whether or not to transmit with a constant pilot power. The UE may monitor the E-RGCH for a pre-determined sequence (e.g., of grant “UP,” “HOLD,” or “DOWN” values) on the relative grant channel (E-RGCH) from the serving E-DCH cell. For example, when the UE determines that it has received the pre-determined sequence, it may transmit with a constant pilot power. The UE may be configured to not apply the relative grant update when receiving the special pre-determined sequence. The UE may receive the grant via the absolute grant channel (E-AGCH).

Systems, methods and instrumentalities may be disclosed for calculating the amount of power to use for the E-DPCCH and S-E-DPCCH when the pilot power is fixed. The UE may be configured to use a fixed amount of power for the E-DPCCH during the fixed pilot power duration such that the NodeB does not use the DPCCH for channel estimation.

There may be no S-E-DPCCH on the secondary stream present. For example, let the configured quantized amplitude ratio (e.g., the baseline value) for the E-DPCCH be A_{ec}, the gain factor for the E-DPCCH be β_{ec} and the gain factor for the kth E-DPDCH PhCH for the jth E-TFC having a maximum of Lmax,j E-DPDCH PhCH be β_{ed,j,k}. The UE may calculate the gain factor of the E-DPCCH based on a configured traffic to total pilot power ratio Δ_{T2TP} (e.g., assuming the power offset Δ_{T2TP} is expressed in (dB)) as follows:

$${β}_{ec} = {β}_{c} \cdot \sqrt{max ( {A}_{ec}^{2} , {10}^{- {Δ}_{T 2 TP} \text{/} 10} \cdot {\sum }_{k = 1}^{{L}_{max , j}} {( \frac{{β}_{ed , j , k}}{{β}_{c}} )}^{2} )}$$

In this example, since DPCCH may not be used for channel estimation, the configured traffic to total pilot power ratio Δ_{T2TP} may be defined as:

$${Δ}_{T 2 TP} = \frac{{\sum }_{k = 1}^{{L}_{max , j}} {( \frac{{β}_{ed , j , k}}{{β}_{c}} )}^{2}}{{β}_{ec}^{2}}$$

There may be an S-E-DPCCH on the secondary stream. It may be assumed that for the secondary stream, the NodeB uses the S-E-DPCCH for channel estimation. In such a case, the configured traffic to total pilot power ratio Δ_{T2TP} for the secondary stream may be provided by:

$${Δ}_{T 2 TP} = \frac{{\sum }_{k = 1}^{{L}_{max , j}} {( \frac{{β}_{sed , j , k}}{{β}_{c}} )}^{2}}{{β}_{sec}^{2}}$$

The UE may compute the gain factor for the S-E-DPCCH based on the power measure offset Δ_{sec} signaled by the network (e.g., as disclosed herein). For example, the UE may calculate the gain factor of the S-E-DPCCH as:

$${β}_{sec} = {β}_{c} \cdot \sqrt{max ( {A}_{sec}^{2} , {10}^{- {Δ}_{sec} \text{/} 10} \cdot {10}^{- {Δ}_{T 2 TP} \text{/} 10} \cdot {\sum }_{k = 1}^{{L}_{max , j}} {( \frac{{β}_{ed , j , k}}{{β}_{c}} )}^{2} )}$$

In the above example for calculating the gain factor for the S-E-DPCCH, the gain factors and the configured traffic to total pilot power ratio Δ_{T2TP} for the E-DPDCH were used. The gain factors for the S-E-DPDCH may be used for that purpose.

Systems, methods and instrumentalities may be disclosed to compensate the gain factors for fixed power transmission. When the UE calculates the gain factor for fixed pilot power transmission, the calculation may be based on the current DPCCH reference. To ensure that the power is maintained for successive slots in the case where the DPCCH power is allowed to be updated by downlink TPC commands, the UE may need to adjust the calculated gain factors to compensate for the changes in DPCCH power.

The gain factors may be calculated on top of DPCCH for the first slot, which may be referred to as a reference slot. To calculate the gain factors for the upcoming slots, the UE may need to track the TPC commands from the first slot to the current slot. Let the change of DPCCH power from the jth slot to the reference slot be Δ_{TPC,j} (e.g., expressed in dB). The E-DPCCH gain factor may be provided by:

β_{ec,j}=10^{Δ}^{_{TPC,j}}^{/20}·β_{ec,ref}

where β_{ec,ref} is the gain factor calculated during the reference slot. The UE may calculate the Δ_{TPC,j} based on the DPCCH power updates, for example by summing up (e.g., in dB) successive power changes since the reference slot.

The above may be applied to other channels, e.g., S-E-DPCCH, E-DPDCH, or S-E-DPDCH. After calculation of the gain factors, the UE may apply the constant pilot power for the duration of the relevant TTI (e.g., according to the conditions as disclosed herein).

Systems, methods and instrumentalities may be disclosed for the UE to indicate to the NodeB the use of a constant pilot power. When the UE uses a constant pilot power during the transmission, the NodeB may need to know beforehand for channel estimation. The UE may inform the NodeB by sending pre-determined signaling. For example, the UE may be configured to use the happy bit in one of the E-DCH control channels to indicate the use of constant pilot power. This may be provided in one or more of the following ways.

As noted above, the happy bit may be re-used to indicate whether or not multiple stream operations are employed for transmission. The UE may use a similar approach to indicate the use of constant pilot power. The UE may be configured to indicate to the NodeB that a constant pilot power has been applied at the UE if the happy bit is set to a pre-determined value. For example, when the UE applies constant pilot power the UE may be configured to set the happy bit of the primary stream E-DPCCH to the value “Happy.” In this case, the happy bit field of the secondary stream E-DPCCH may be used to carry the actual happy bit.

The UE may set the happy bit of the secondary stream E-DPCCH to the value “Happy” when constant pilot power is applied. In this case, the UE may use the happy bit field of the primary stream E-DPCCH to carry the actual happy bit.

With the introduction of 64QAM and MIMO on the uplink, the existing power boosting mechanism for the E-DPCCH may not be sufficient to provide appropriate pilot power at the NodeB. Systems, methods and instrumentalities may be disclosed for multi-level boosting (e.g., different levels of power boosting) of the control channel(s), which may improve channel estimation at the NodeB for improved performance.

The UE may determine when to apply multi-level boosting. The following may be used in any order or combination. The UE may be configured, for example, via RRC signaling to apply multi-level boosting. The UE may be configured to apply multi-level boosting based on the E-DCH transmission format. For example, the UE may be configured to apply multi-level boosting when one or more of the following are met: the UE transmits with 64QAM modulation; the UE transmits with MIMO; the primary stream TBS/E-TFCI that the UE transmits is above a threshold; the secondary stream TBS/E-TFCI that the UE transmits is above a threshold; the sum of the TBS from both the primary and the secondary stream that the UE transmits is above a threshold; the UE transmit power is above a threshold; the UE E-DPDCH transmit power is above a threshold; the UE S-E-DPDCH transmit power is above a threshold; the sum of the UE E-DPDCH and S-E-DPDCH transmit power is above a threshold; etc. The threshold values may be fixed, e.g., in a specification, signaled to the UE via RRC signaling, etc.

The UE may be configured to apply multi-level boosting when it receives a specific configuration from the network. For example, the UE may be configured to apply multi-level boosting when one or more of the following are met: the UE is configured to apply multi-level boosting; the UE is configured to operate with 64QAM modulation; the UE is configured to operate with MIMO; the UE is configured to operate with both 64QAM and MIMO; the UE receives an absolute grant (e.g., on the E-AGCH) above a pre-configured threshold; the UE serving grant is above a pre-configured threshold; the UE receives a special value of the absolute grant or a certain combination of bits on the E-AGCH; the UE receives a certain HS-SCCH order; etc.

The UE may receive an L2 (e.g., MAC-level) message and determine if and/or how much power boosting should be applied. Depending on the transmitter structure, e.g., as disclosed herein, the multi-level boosting may be applied on the E-DPCCH, S-E-DPCCH, S-DPCCH, or a combination of the above. The amount of power boosting for the TBS values may be computed off-line in advance and stored and/or configured at the UE by means of a mapping table.

A configurable interpolation formula may be used. A subset of the required power boosting values may be computed and/or pre-determined from empirical experiments first, and then an interpolation technique may be applied to determine the rest of the values. As an example, the UE may be configured by the network with a set of one or more reference parameters and possible a set of one or more thresholds. The reference and threshold parameters may comprise of one or more of the following: E-TFCI; transport block size index; and an index to a table of an E-DPDCH power (e.g., over one or two streams), E-DPCCH power (e.g., over one or two streams), and a total number of bits transmitted on the E-DCH (e.g., over one or two streams); etc.

It may be assumed that the UE is configured to use the E-TFCI as a parameter and/or threshold. If at least one of condition for applying multi-level boosting is met, the UE may be configured to calculate the value of the multi-level boosting. For example, given an E-TFCI, the UE may interpolate the value of the multi-level boosting (e.g., for instance using linear interpolation) based on the reference parameters configured. The UE may apply the calculated multi-level boosting on the appropriate channels. The UE may be configured with a maximum or baseline boosting which is not to be exceeded.

The UE may be configured to pre-calculate the multi-level boosting values for each E-TFCI, e.g., after receiving the configuration reference parameters. For each E-TFCI, the UE may determine the actual boosting based on its pre-calculated table.

A second T2TP value with an E-TFCI threshold may be used. When multi-level boosting is applied, a second T2TP value may be used to further increase the pilot power for channel estimation at the NodeB. For example, the UE may be configured by the network with a set of one or more thresholds and associated T2TP values. The threshold parameters may comprise of one or more of the following: an E-TFCI; a transport block size index; an index to a table of an E-DPDCH power (e.g., over one or two streams), an E-DPCCH power (e.g., over one or two streams), and/or a total number of bits transmitted on the E-DCH (e.g., over one or two streams); etc.

It may be assumed that the UE is configured to use the E-TFCI as a parameter and/or threshold. If at least one of condition for applying multi-level boosting is met, the UE may be configured to calculate the value of the multi-level boosting. For example, given an E-TFCI that exceeds an E-TFCI threshold, the UE may apply a second T2TP (e.g., ΔT2TPml) to calculate the multi-level boosting, e.g., on the appropriate channel(s). The E-TFCI threshold (e.g., E-TFCIboost,ml) and the associated T2TP value (e.g., ΔT2TPml) may be pre-determined or signaled from the network, e.g., for example via RRC signaling.

A set of T2TP values (ΔT2TPml,k) and associated E-TFCI thresholds (E-TFCIboost,ml,k), e.g., indexed by variable k, may be included. In an example, given an E-TFCI that falls within a certain range, the corresponding T2TP may be applied to calculate multi-level boosting, e.g., on the appropriate channels. The E-TFCI switch points and list of T2TP values may be pre-determined at the UE, signaled from the network, etc.

The UE may be configured to pre-calculate multi-level boosting values for each E-TFCI, for example after receiving the configuration reference parameters. For each E-TFCI, the UE may determine the actual boosting based on its pre-calculated table.

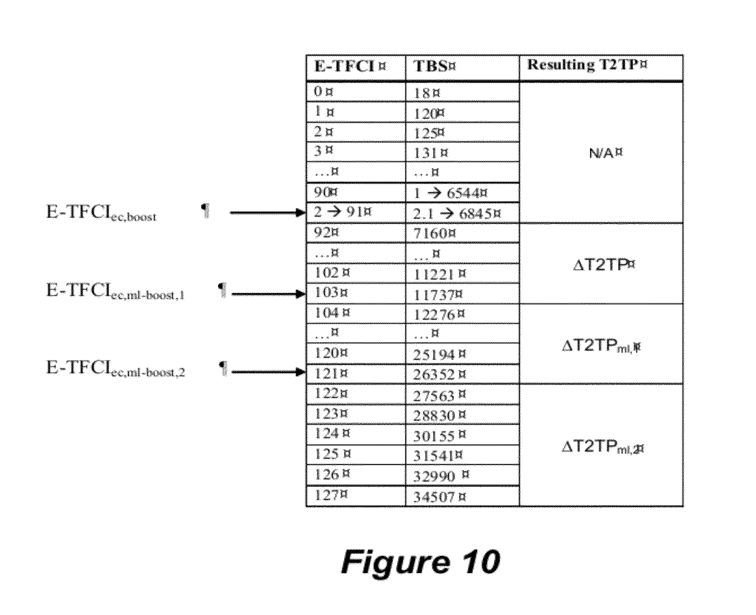

FIG. 10 illustrates exemplary multi-level boosting based on an E-TFCI. In the example, the UE may be configured with three threshold values and an associated T2TP: the conventional E-TFCIec,boost and ΔT2TP, and, two additional thresholds and T2TP values for multi-level boosting, E-TFCIec,ml-boost,1 and E-TFCIec,ml-boost,2 and the associated ΔT2TPml,1 and ΔT2TPml,2 respectively. As illustrated in FIG. 10, the UE may determine the resulting T2TP value to apply in calculating the E-DPCCH power offset for a given E-TFCI based on the threshold configured and the associated T2TP. One or more of the following may apply in the example of FIG. 10. If the E-TFCI is larger than E-TFCIec,boost then the UE may use ΔT2TP in calculating the E-DPCCH or associated control channel gain factor. If the E-TFCI is larger than E-TFCIec,ml-boost,1 then the UE may use ΔT2TPml,1 in calculating the E-DPCCH or associated control channel gain factor. If the E-TFCI is larger than E-TFCIec,ml-boost,2 then the UE may use ΔT2TPml,2 in calculating the E-DPCCH or associated control channel gain factor. Otherwise, the UE may use the configured (e.g., non-boosted) gain factor for the E-DPCCH or associated control channel gain factor.

A non-linear function may be used. A multi-level boosting may be formulated by a nonlinear function, which may rely on the primary and/or the secondary TBS, modulation type, and the number of streams used for transmissions. An example is to determine a subset of power boosting values across different TBSs, modulation types, and numbers of streams. Then, a curve fitting technique may be employed to determine the nonlinear function and associated parameters.

The UE may be configured with a pre-determined curve fitting function. If at least one of the conditions for applying multi-level boosting is met, the UE may be configured with one or more parameters from the network for the curve fitting function. The UE may determine the multi-level boosting based on the curve fitting with the signaled parameters.

An incremental reference table may be used. In an example, the UE may be configured with an increment power reference table or gain reference table. The UE may be configured to calculate the power of the E-DPCCH and may be configured to calculate the power of the S-E-DPCCH, e.g., using the conventional power boosting approach. The UE may further be configured to determine and apply an additional boosting factor, which may increase the power of the relevant control channel.

The UE may be configured to determine the amount of additional boosting, e.g., based on one or more of the following: E-TFCI, transport format, modulation scheme, number of MIMO streams, power of associated data channel, etc.

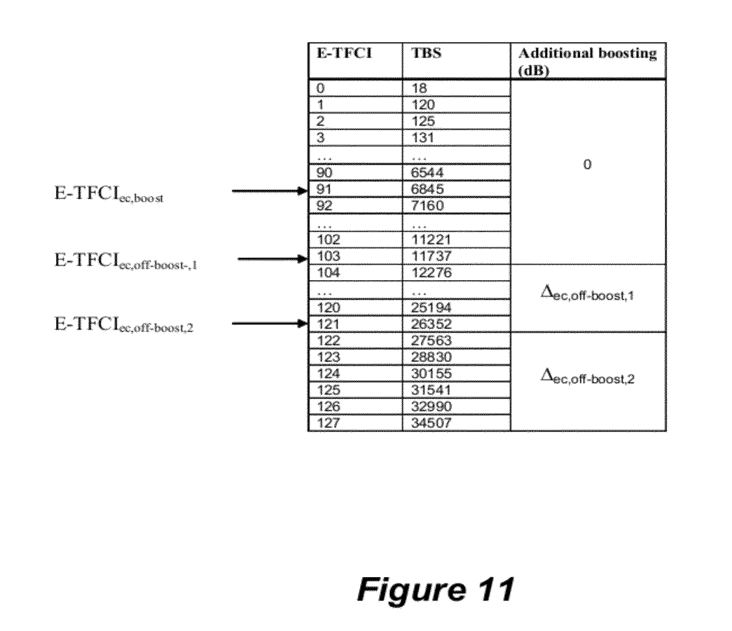

In an example, the UE may be configured with one or more E-TFCI threshold and associated additional boosting level. Let E-TFCIec,off-boost,k and Δec,off-boost,k be the kth E-TFCI threshold and associated additional boosting level, respectively. The UE may be configured to apply the configured additional boosting when the E-TFCI transmitted or selected is above an associated configured threshold. FIG. 11 illustrates exemplary multi-level boosting with one or more E-TFCI thresholds and associated additional boosting, where in this example k=1,2. In this example, one or more of the following may apply. If the E-TFCI is larger than E-TFCIec,off-boost,1 then the UE may use ΔT2TP and apply the Δec,off-boost,1 offset in calculating the E-DPCCH or associated control channel gain factor. If the E-TFCI is larger than E-TFCIec,off-boost,2 then the UE may use ΔT2TP and apply the Δec,off-boost,2 offset in calculating the E-DPCCH or associated control channel gain factor. Otherwise, the UE may not apply additional boosting to the E-DPCCH or associated control channel gain factor. The present example may be based on a configured E-TFCI threshold. This concept may be applied with different triggers and/or parameters, e.g., as disclosed herein.

A UE may indicate use of multi-level boosting to the nodeB. When multi-level boosting is applied during the transmission, the nodeB may need to know beforehand, e.g., for channel estimation. The UE may need to inform the nodeB by sending some pre-determined signaling. For example, the UE may use the happy bit in one of the E-DCH control channels, e.g., as described herein.

As described herein, the happy bit may be used to indicate whether or not multiple stream operations are employed for transmission. The UE may indicate to the NodeB that multi-level boosting has been applied at the UE if the happy bit is set to a pre-determined value. For example, when the UE applies multi-level boosting, the UE may be configured to set the happy bit of the primary stream E-DPCCH to the value “Happy.” In such a case, the happy bit field of the secondary stream E-DPCCH may be used to carry the actual happy bit. The UE may set the happy bit of the secondary stream E-DPCCH to the value “Happy” when the multi-level boosting is applied. In such a case, the UE may use the happy bit field of the primary stream E-DPCCH to carry the actual happy bit.

A UE may be limited to transmitting a single transport block, e.g., regardless of the number of layers (e.g., 1 or 2) being used for transmission. In such a case, the UE may be configured in an open-loop configuration or in a closed-loop configuration.

In an open-loop configuration, the UE may be configured with fixed rules linking the transport block size to the transport format, including the transmission rank. The UE may be configured with a one-to-one mapping between the transport block sizes and transport format combination (e.g., which may include rank) and the E-TFCI transmitted on the uplink. In such a case, the UE may indicate the legacy transport format (e.g., spreading factor, number of E-DPDCH codes, modulation scheme (e.g., QPSK, 16QAM, or 64QAM if applicable), etc.) with the E-TFCI and the rank. As an example, the UE may be configured via a set of parameters, which may include one or more of the following; the legacy puncturing limit (e.g., PLnon-max); one or more data rate or puncturing limit parameters for modulation switching (e.g., from QPSK to 16QAM (e.g., PLmod-switch) and from 16QAM to 64QAM); and, one or more data rate or puncturing limit parameters for rank switching (e.g., from rank-1 to rank-2 transmission).

The UE may determine the transport block size and determine the transport format, which may include the spreading factor, number of codes, modulation and rank, etc. The UE may indicate on the E-DPCCH the corresponding E-TFCI. Table 1 shows an exemplary E-TFCI mapping to transport format (e.g., modulation and rank shown for illustrative purposes).

TABLE 1

| E-TFCI | TBS | Modulation | Rank |
|---|---|---|---|
| 0 | 18 | BPSK | 1 |
| 1 | 120 | BPSK | 1 |
| . . . | . . . | . . . | . . . |
| 20 | 610 | QPSK | 1 |
| . . . | . . . | . . . | . . . |
| 51 | 8105 | 16QAM | 1 |
| . . . | . . . | . . . | . . . |
| 60 | 17173 | 16QAM | 2 |
| . . . | . . . | . . . | . . . |
| 80 | 22995 | 16QAM | 2 |
| . . . | . . . | . . . | . . . |
| 95 | 45990 | 64QAM | 2 |
| . . . | . . . | . . . | . . . |
| 127 | 91980 | 64QAM | 2 |

When the NodeB decodes the E-TFCI on the E-DPCCH, it may determine the actual transport format and rank by using the look-up table. An E-TFCI mapping table may comprise multiple entries for a TBS. This may allow the UE, for example, to explicitly indicate the rank and transport format without a one-to-one transport format to TBS mapping (e.g., rather a one-to-one E-TFCI to transport format and TBS mapping). In an example, the UE may be configured such that an E-TFCI above N_{DS} may correspond to an E-TFCI with rank-two transmission. The value of N_{DS} may be pre-defined or configured via higher layers.

Table 2 shows an exemplary E-TFCI table with TBS to indicate rank for the example value N_{DS}=122.

TABLE 2

| E-TFCI | TBS | Rank |
|---|---|---|
| 0 | 18 | 1 |
| . . . | . . . | . . . |
| 118 | 19462 | 1 |
| 119 | 20291 | 1 |
| 120 | 21155 | 1 |
| 121 | 22056 | 1 |
| 122 | 22995 | 1 |
| 123 | 19462 | 2 |
| 124 | 20291 | 2 |
| 125 | 21155 | 2 |
| 126 | 22056 | 2 |
| 127 | 22995 | 2 |

This concept may be used when multiple modulation schemes are configured.

The UE may be configured by the network to use rank-1 or rank-2 transmissions semi-statically. When the UE is configured for rank-1 transmission, the UE may use the portion of the table corresponding to rank-1 transmissions, and when it is configured for rank-2 transmissions, the UE may use the portion of the table corresponding to rank-2 transmissions.

In an open-loop configuration, the UE may be configured to transmit a single transport block and adapt a transmission rate on the secondary stream based on a NodeB quality indication. The UE may transmit the E-TFCI on the E-DPCCH, which may be configured with a one-to-one mapping with the TBS being carried on the E-DCH, e.g., regardless of the transmission rank. The UE may transmit an indication qualifying the amount of information being transmitted on the secondary stream. This indication may be referred to as a secondary stream format indication (SSFI). The NodeB may demodulate and decode the E-DCH based on the combined information.

There may be a secondary stream format indication. The SSFI may indicate a number of coded bits carried on the secondary stream. The UE may indicate a zero SSFI when single-stream transmission is taking place, e.g., indicating the transmission rank explicitly. The UE may be configured to transmit with a fixed transport format on the secondary stream when dual-stream transmission takes place, e.g., when the UE is using dual-stream transmission, it may transmit using the 2SF2+2SF4 with 16 QAM transport format. When the UE is configured for 64QAM operations, the UE may be configured to transmit using the 2SF2+2SF4 with 64QAM transport format. To adapt the data rate the UE may apply physical layer repetition on the E-DPDCH for the second stream. In such cases, the UE may have a fixed number of E-DPDCH symbols and may use repetition encoding to adapt to the channel quality. The UE may signal the repetition factor over the SSFI, which may correspond to a fixed number of coded bits transmitted on the secondary stream depending on the modulation. Table 3 shows an example of SSFI table mapping.

TABLE 3

| | | Corresponding number of | | |
|---|---|---|---|---|
| | | coded bits transmitted on | | |
| | | second stream | | |
| SSFI | Repetition factor | QPSK | 16 QAM | 64 QAM |
| 0 | N/A | 0 | 0 | 0 |
| 1 | 0 | 11520 | 23040 | 46080 |
| 2 | 1 | 5760 | 11520 | 23040 |
| 3 | 2 | 3840 | 7680 | 15360 |
| 4 | 3 | 2880 | 5760 | 11520 |
| 5 | 4 | 2304 | 4608 | 9216 |
| 6 | 7 | 1440 | 2880 | 5760 |
| 7 | 15 | 95 | 190 | 380 |

In the example shown in Table 3, the UE indicates an SSFI value of 0 when no information is transmitted on the secondary stream. When the UE indicates value 1 for the SSFI, it corresponds to a 0 repetition factor (e.g., no repetition). A value of 2 corresponds to a repetition factor of 2, halving the number of symbols being transmitted, etc. The UE may determine the number of bits to transmit on the secondary stream and adjust its rate matching and other transmission parameters for the primary stream based on the remaining bits to transmit on the primary stream.

A control channel design may be provided. The SSFI may be transmitted in a field of the E-DPCCH, which may be created or existing. The SSFI may be carried on an S-E-DPCCH channel, which may be created or existing. For the 1 TB case, there may be no need for an additional RSN field and the number of bits to carry in total may be less than the 2 TB case.

The UE may multiplex, encode and transmit the following information, e.g., on a single E-DPCCH code.
E-TFCI (e.g., 7 bits)
SSFI (e.g., 3 bits)
RNS (e.g., 2 bits)
HB (e.g., 1 bit)
   The UE may then for example encode the 13 bits using a Reed-Mueller code. The Reed-Mueller code may be created, may be an extension of an existing code, etc. Modulation and rank information may be included.

The UE may be configured with a single E-DPCCH with reduced spreading factor (e.g., SF=128), carrying more information symbols. The UE may be configured to perform channel coding with a channel coding scheme (e.g., created or existing), which may be based for example on: an extended Reed-Muller code; a convolution code (e.g., rate ½ or rate ⅓); etc.

The secondary E-TFCI may be encoded using difference indexing. When the primary stream has better quality than the secondary stream, the UE may be configured in such a way as to transmit a lower E-TFC on the secondary stream. In such cases, the E-TFCI for the secondary stream may be smaller or equal to the primary stream E-TFCI, and, a number of entries in the E-TFCI table for the secondary stream may not be reached. A differential encoding approach may be used to signal the secondary stream E-TFCI. By using this approach, it may be possible to reduce the amount of control information (e.g., by having a smaller field size for the differential E-TFCI). The following may refer to an E-TFCI_{D}, which may refer to a differential E-TFC index for the secondary stream.

Differential encoding for the secondary E-TFCI may be performed according to one or more of the following. The UE may determine an E-TFCI for the primary stream, E-TFCI_{P}. The UE may determine the secondary stream E-TFCI, E-TFCI_{S}. The UE may determine the value of the differential E-TFCI for the secondary stream E-TFCI_{D} (e.g., by using one of the approaches disclosed herein). The UE may transmit the E-TFCI_{P} and E-TFCI_{D} over the E-DPCCH and/or S-E-DPCCH.

Exemplary approaches for the UE to determine the value of the differential E-TFCI for the secondary stream (E-TFCI_{D}) may be disclosed. The approaches may use absolute indexing. As an example, a field size of 7 bits may be assumed (0-127) for the E-TFCIs. The approaches disclosed herein may be applied to other sizes (e.g., 5 bits (0-31)) and is not limited to E-TFCI's of the same size. The approaches may be described from the UE perspective. The NodeB may perform the inverse operation to obtain the E-TFCI_{S} from the E-TFCI_{D} and E-TFCI_{P}.

The differential E-TFCI for the secondary stream may be calculated as follows:

E-TFCI_{D}=E-TFCI_{S}-E-TFCI_{P}

With this approach, when the UE signals value E-TFC_{D}=0, both E-TFCI's may be the same. Value E-TFC_{D}=127 (or E-TFC_{D}=all 1's in binary regardless of the number of bits allocated to the E-TFC_{D}) may be reserved, for example, which may indicate that secondary transport blocks are not present (e.g., the UE is transmitting using single stream).

The UE may encode the E-TFCI_{D} using:

E-TFCI_{D}=max(127−(E-TFCI_{S}-E-TFCI_{P})

With this approach, value 127 may indicate that the secondary E-TFC is the same as the primary E-TFC. A value of 0 may indicate a maximum difference (e.g., lower E-TFC for the secondary stream). The value 0 may be reserved in that case to indicate that no secondary TB is present.

It may be rare that the secondary stream has the same E-TFC as the primary stream (e.g., by the nature of the MIMO channel). It may be preferable to reserve the value 127 to indicate that the secondary stream carries no data and the E-TECI_{D} may be encoded as follows:

E-TFCI_{D}=max(126−(E-TFCI_{S}-E-TFCI_{P})

It may be possible for the UE to use a different TBS size table for the primary and secondary stream. This may provide optimization of the control channel.

A NodeB may provide control of antenna operations. State-based HS-SCCH order mapping for controlling (e.g., activation and/or deactivation) of UL CLTD and/or MIMO may be used such that based on the total number of states or configurations N, log 2(N) bits may be required to represent these states. These bits may be from order bits (e.g., x_{ord},1, x_{ord},2, x_{ord},3) or order type (e.g., x_{odt},1, x_{odt},2, x_{odt},3) in 6-bit or 8-bit order mapping tables or extended order bits from a TBS field (e.g., x_{tbs},5, x_{tbs},6) in an 8-bit order mapping table. The mapping between order bits and states may be in a pre-defined and/or specified order. Implementations may include one or more of the following.

The UE may be configured to receive an HS-SCCH where the combinations of the order bits indicate the UE antenna configuration. Table 4 illustrates an exemplary state-based order mapping. In the example shown in Table 4, possible configurations are illustrated. These configurations (e.g., states) may be encoded using 3 order bits.

TABLE 4

| Order bit 1 | Order bit 2 | Order bit 3 | Configuration |
|---|---|---|---|
| 0 | 0 | 0 | 4 (UL CLTD deactivated - |
| | | | primary antenna is used) |
| 0 | 0 | 1 | 5 (UL CLTD deactivated - |
| | | | secondary antenna is used) |
| 0 | 1 | 0 | 2 (S-DPCCH activated and |
| | | | transmitted on secondary |
| | | | antenna) |
| 0 | 1 | 1 | 3 (S-DPCCH activated and |
| | | | transmitted on primary |
| | | | antenna) |
| 1 | 0 | 0 | 1 (UL CLTD activated) |
| 1 | 0 | 1 | Reserved |
| 1 | 1 | 0 | Reserved |
| 1 | 1 | 1 | Reserved |

Table 5 illustrates exemplary state-based order mapping supporting possible configurations with UL MIMO (e.g., with dual-stream support). When the UE is configured with one of states 5-7, the UE may transmit with two streams. In state 5, the primary stream is mapped to the primary antenna; in state 6, the primary stream is mapped to the secondary antenna; and, in state 7, the UE follows the F-PCICH precoding weight indication for weight selection.

TABLE 5

| | Order bit # | | | |
|---|---|---|---|---|
| State | 1 | 2 | 3 | Configuration |
| 0 | 0 | 0 | 0 | 4 (UL CLTD deactivated - primary antenna is used) |
| 1 | 0 | 0 | 1 | 5 (UL CLTD deactivated - secondary antenna is |
| | | | | used) |
| 2 | 0 | 1 | 0 | 2 (S-DPCCH activated and transmitted on secondary |
| | | | | antenna) |
| 3 | 0 | 1 | 1 | 3 (S-DPCCH activated and transmitted on primary |
| | | | | antenna) |
| 4 | 1 | 0 | 0 | 1 (UL CLTD activated) |
| 5 | 1 | 0 | 1 | Dual stream operations with primary stream mapped |
| | | | | to primary antenna |
| 6 | 1 | 1 | 0 | Dual stream operations with primary stream mapped |
| | | | | to secondary antenna |
| 7 | 1 | 1 | 1 | Dual stream operations |

Table 6 illustrates exemplary state-based order mapping supporting possible configurations with UL MIMO. When the UE is configured with state 5, it operates with dual stream operations. In state 5, the UE may apply the pre-coding weights in the manner as when configured with UL CLTD; the UE may apply a different set of pre-coding weights (e.g., thereby switching the codebook).

TABLE 6

| | Order bit # | | | |
|---|---|---|---|---|
| State | 1 | 2 | 3 | Configuration |
| 0 | 0 | 0 | 0 | 4 (UL CLTD deactivated - primary antenna is used) |
| 1 | 0 | 0 | 1 | 5 (UL CLTD deactivated - secondary antenna is |
| | | | | used) |
| 2 | 0 | 1 | 0 | 2 (S-DPCCH activated and transmitted on |
| | | | | secondary antenna) |
| 3 | 0 | 1 | 1 | 3 (S-DPCCH activated and transmitted on |
| | | | | primary antenna) |
| 4 | 1 | 0 | 0 | 1 (UL CLTD activated) |
| 5 | 1 | 0 | 1 | Dual stream operations |
| 6 | 1 | 1 | 0 | Reserved |
| 7 | 1 | 1 | 1 | Reserved |

Table 7 illustrates exemplary state-based order mapping supporting possible configurations with UL MIMO as a separate state. The UE may receive an HS-SCCH order (e.g., when configured for UL MIMO operations) to move to state 5, in which case it may start operating in dual-stream MIMO operations.

TABLE 7

| | Order bit # | | | |
|---|---|---|---|---|
| State | 1 | 2 | 3 | Configuration |
| 0 | 0 | 0 | 0 | 4 (UL CLTD deactivated - primary antenna is used) |
| 1 | 0 | 0 | 1 | 5 (UL CLTD deactivated - secondary antenna is |
| | | | | used) |
| 2 | 0 | 1 | 0 | 2 (S-DPCCH activated and transmitted on |
| | | | | secondary antenna) |
| 3 | 0 | 1 | 1 | 3 (S-DPCCH activated and transmitted on |
| | | | | primary antenna) |
| 4 | 1 | 0 | 0 | 1 (UL CLTD activated) |
| 5 | 1 | 0 | 1 | Dual stream operations |
| 6 | 1 | 1 | 0 | Reserved |
| 7 | 1 | 1 | 1 | Reserved |

In a state-based approach, a separate entry for an UL MIMO configuration may not be provided in a HS-SCCH table. When the UE is configured in UL MIMO mode, it may re-interpret one or more entry of the UL CLTD table. Table 8 illustrates an exemplary state-based order mapping supporting possible configurations. In this example, the NodeB may configure the UE in normal UL CLTD operations by configuring the UE rank to 1 or the serving grant for the secondary stream to 0 via another signalling mechanism (e.g., a modified E-AGCH, E-RGCH, or other signal). When the UE is configured in the other states (e.g., states 0-3), the UE may operate as in UL CLTD mode (e.g., with single stream operations).

TABLE 8

| | Order bit | | Order bit | |
|---|---|---|---|---|
| State | 1 | Order bit 2 | 3 | Configuration |
| 0 | 0 | 0 | 0 | 4 (UL CLTD deactivated - |
| | | | | primary antenna is used) |
| 1 | 0 | 0 | 1 | 5 (UL CLTD deactivated - |
| | | | | secondary antenna is used) |
| 2 | 0 | 1 | 0 | 2 (S-DPCCH activated and |
| | | | | transmitted on secondary |
| | | | | antenna) |
| 3 | 0 | 1 | 1 | 3 (S-DPCCH activated and |
| | | | | transmitted on primary |
| | | | | antenna) |
| 4 | 1 | 0 | 0 | UL MIMO operations |
| 5 | 1 | 0 | 1 | Reserved |
| 6 | 1 | 1 | 0 | Reserved |
| 7 | 1 | 1 | 1 | Reserved |

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A method to determine a gain factor associated with multiple stream uplink operations in a user equipment (UE), the method comprising:
determining that the UE is to transmit on a primary stream and a secondary stream;
determining a first minimum gain factor for an S-E-DPCCH;
determining whether boosting needs to be applied to the S-E-DPCCH;
determining a first gain factor for the S-E-DPCCH; and
transmitting, over the primary stream, the S-E-DPCCH using the first gain factor.

2. The method of claim 1, wherein it is determined that boosting needs to be applied when one or more of the following is met: an E-TFCI value is above a threshold, the secondary stream carries data, and boosting is enabled.

3. The method of claim 1, wherein an E-DPCCH is transmitted over the primary stream.

4. The method of claim 1, wherein the first gain factor is determined based on a maximum value of: a minimum value configured by a network, a value calculated based on E-DPDCH power, or a traffic to secondary pilot ratio.

5. The method of claim 1, further comprising setting a field of an E-DPCCH to indicate a presence of the secondary stream, wherein the field is a happy bit field of the E-DPCCH.

6. The method of claim 5, wherein the field of the E-DPCCH is set to an unhappy state to indicate the presence of the secondary stream.

7. The method of claim 6, further comprising using a field of the S-E-DPCCH to carry the happy bit from the E-DPCCH.

8. The method of claim 1, further comprising:
determining a second minimum gain factor for an S-DPCCH;
determining whether boosting needs to be applied to the S-DPCCH; and
determining a second gain factor for the S-DPCCH.

9. The method of claim 8, wherein the second gain factor is calculated by:
$${β}_{sc} = {β}_{c} \sqrt{max ( {A}_{sc}^{2} , \frac{{β}_{sc , ss}^{2}}{{β}_{c}^{2}} , \frac{{\sum }_{k = 1}^{{K}_{max , i}} {β}_{sed , i , k}^{2} \text{/} {β}_{c}^{2}}{{10}^{{Δ}_{ST 2 P} \text{/} 10}} )}$$

10. A user equipment comprising:
a processor configured to:
determine that the UE is to transmit on a primary stream and a secondary stream;
determine a first minimum gain factor for an S-E-DPCCH;
determine whether boosting needs to be applied to the S-E-DPCCH; and
determine a first gain factor for the S-E-DPCCH; and
a transmitter configured to:
transmit, over the primary stream, the S-E-DPCCH using the first gain factor.

11. The user equipment of claim 10, wherein it is determined that boosting needs to be applied when one or more of the following is met: an E-TFCI value is above a threshold, the secondary stream carries data, and boosting is enabled.

12. The user equipment of claim 10, wherein the transmitter is further configured to transmit an E-DPCCH over the primary stream.

13. The user equipment of claim 10, wherein the first gain factor is determined based on a maximum value of: a minimum value configured by a network, a value calculated based on E-DPDCH power, or a traffic to secondary pilot ratio.

14. The user equipment of claim 10, wherein the processor is further configured to set a field of an E-DPCCH to indicate a presence of the secondary stream, wherein the field is a happy bit field of the E-DPCCH.

15. The user equipment of claim 15, wherein the field of the E-DPCCH is set to an unhappy state to indicate the presence of the secondary stream.

16. The user equipment of claim 16, wherein the processor is further configured to use a field of the S-E-DPCCH to carry the happy bit from the E-DPCCH.

17. The user equipment of claim 10, wherein the processor is further configured to:
determine a second minimum gain factor for an S-DPCCH;
determine whether boosting needs to be applied to the S-DPCCH; and
determine a second gain factor for the S-DPCCH.

18. The user equipment of claim 17, wherein the second gain factor is calculated by:
$${β}_{sc} = {β}_{c} \sqrt{max ( {A}_{sc}^{2} , \frac{{β}_{sc , ss}^{2}}{{β}_{c}^{2}} , \frac{{\sum }_{k = 1}^{{K}_{max , i}} {β}_{sed , i , k}^{2} \text{/} {β}_{c}^{2}}{{10}^{{Δ}_{ST 2 P} \text{/} 10}} )}$$
